(19) United States
(12) Patent Application Publication
(10) Pub. No.: US 2026/0180967 A1
(43) Pub. Date: Jun. 25, 2026

(54) INFORMATION TRANSMISSION METHOD AND APPARATUS, COMMUNICATION DEVICE, AND STORAGE MEDIUM

(71) Applicant: Beijing Xiaomi Mobile Software Co., Ltd., Beijing (CN)

(72) Inventors: Haoran LIANG, Beijing (CN); Wei LU, Beijing (CN)

(21) Appl. No.: 19/125,004

(22) PCT Filed: Oct. 31, 2022
(86) PCT No.: PCT/CN2022/128799

§ 371 Date: Apr. 28, 2025

(51) Int. Cl. H04L 9/40; H04W 48/16

(52) U.S. Cl. CPC H04L 63/08; H04W 48/16

(57) ABSTRACT

An information transmission method is performed by a unified data management (UDM) and includes: setting, for extended steering information to be sent, a first verification credential used for integrity verification of user equipment (UE) on the extended steering information, wherein the first verification credential is determined at least according to the extended steering information.

### CROSS REFERENCE TO RELATED APPLICATION

This application is a US National Stage of International Application No. PCT/CN2022/128799, filed on Oct. 31, 2022, the content of which is incorporated by reference herein in its entirety.

### TECHNICAL FIELD

The present application relates to, but is not limited to, the field of wireless communication technology, and in particular to information transmission methods, apparatuses, a communication device and a storage medium.

### BACKGROUND

Roaming refers to the function that the mobile communication system can still provide services to User Equipment (UE) after UE leaves the service area where it is registered and moves to another service area.

The Home Public Land Mobile Network (HPLMN) is the PLMN to which the terminal user belongs. That is to say, the Mobile Country Code (MCC) and Mobile Network Code (MNC) of this PLMN are consistent with the MCC and MNC contained in the International Mobile Subscriber Identity (IMSI) of UE. Generally, for a certain UE, there is only one PLMN to which it belongs.

The Visited Public Land Mobile Network (VPLMN) is obtained from the current network. The MCC and MNC contained in its PLMN are not exactly the same as that contained in the IMSI of UE. UE will maintain a VPLMN list internally to store PLMN identification information issued by the visited network. When the UE hands over or roams, it is to register to the visited VPLMN.

### SUMMARY

According to a first aspect of embodiments of the present disclosure, an information transmission method is proposed, which is performed by Unified Data Management (UDM) and includes:
setting, for extended steering information to be sent, a first verification credential used for integrity verification of user equipment UE on the extended steering information, where the first verification credential is determined at least according to the extended steering information.

In some embodiments, the method further includes:
sending the extended steering information to at least an authentication service function (AUSF), where the extended steering information is used for determination of the AUSF on the first verification credential; and
receiving the first verification credential determined by the AUSF.

In some embodiments, setting, for the extended steering information to be sent, the first verification credential used for integrity verification of the UE on the extended steering information includes:
sending the extended steering information and the first verification credential to an access and mobility management function (AMF), where the extended steering information and the first verification credential are to be sent to the UE by the AMF.

In some embodiments, the extended steering information is at least used for determination of the UE on a second verification credential, and for verification of the UE on the extended steering information based on the first verification credential and the second verification credential.

In some embodiments, sending the extended steering information and the first verification credential to the AMF includes one of following:
sending a steering of roaming (SOR) transparent container to the AMF, where the SOR transparent container carries the extended steering information and/or the first verification credential;
sending SOR indication information to the AMF, where the extended steering information and the first verification credential are respectively carried in information elements IEs of the SOR indication information.

In some embodiments, the extended steering information includes at least one of following:
enhanced slice awareness information;
a prioritized list of preferred stand-alone non-public network SNPN controlled by a credential holder;
a prioritized list of preferred group IDs for network selection GIN controlled by the credential holder;
a hosting network prioritized list.

In some embodiments, the enhanced slice awareness information includes: information on a preferred public land mobile network PLMN for specific single network slice selection assistance information (S-NSSAI) in subscription information of the UE.

In some embodiments, the information on the preferred PLMN of the specific S-[0013] NSSAI in the subscription information of the UE includes at least one of following:
a single PLMN that supports S-NSSAI known to an HPLMN;
a list of PLMNs arranged in preference order.

In some embodiments, the hosting network prioritized list includes: indication information of a hosting network, where the indication information indicates at least one of following:
time information of when the hosting network is valid;
location information of where the hosting network is valid.

According to a second aspect of embodiments of this disclosure, an information transmission method is proposed, which is performed by an authentication service function AUSF and includes:
setting, for extended steering information, a first verification credential used for integrity verification of user equipment UE on the extended steering information, where the first verification credential is determined at least according to the extended steering information.

In some embodiments, setting, for the extended steering information, the first verification credential used for integrity verification of the UE on the extended steering information includes:
receiving the extended steering information sent by a unified data management UDM;
determining the first verification credential based at least on the extended steering information; and
sending the first verification credential to the UDM.

In some embodiments, the extended steering information is at least used for determination of the UE on a second verification credential, and for verification of the UE on the extended steering information based on the first verification credential and the second verification credential.

In some embodiments, the extended steering information includes at least one of following:
enhanced slice awareness information;
a prioritized list of preferred stand-alone non-public network (SNPN) controlled by a credential holder;
a prioritized list of preferred group IDs for network selection (GIN) controlled by the credential holder;
a hosting network prioritized list.

In some embodiments, the enhanced slice awareness information includes: information on a preferred public land mobile network PLMN for specific single network slice selection assistance information S-NSSAI in subscription information of the UE.

In some embodiments, the preferred PLMN of the specific S-NSSAI in the subscription information of the UE includes at least one of following:
a single PLMN that supports S-NSSAI known to an HPLMN;
a list of PLMNs arranged in preference order.

In some embodiments, the hosting network prioritized list includes: indication information of a hosting network, where the indication information indicates at least one of following:
time information of when the hosting network is valid;
location information of where the hosting network is valid.

According to a third aspect of embodiments of the present disclosure, an information transmission method is proposed, which is performed by an access and mobility management function AMF and includes:
receiving extended steering information and a first verification credential sent by a unified data management UDM, where the first verification credential is used for integrity verification of user equipment UE on the extended steering information, and the first verification credential is determined at least according to the extended steering information.

In some embodiments, the method further includes:
sending the extended steering information and the first verification credential to the UE, where the extended steering information is at least used for determination of the UE on a second verification credential, and for verification of the UE on the extended steering information based on the first verification credential and the second verification credential.

In some embodiments, receiving the extended steering information and the first verification credential sent by the UDM includes one of following:
receiving a steering of roaming SOR transparent container sent by the UDM, where the SOR transparent container carries the extended steering information and/or the first verification credential;
receiving SOR indication information sent by the UDM, where the extended steering information and the first verification credential are respectively carried in the information elements IEs of the SOR indication information.

In some embodiments, in response to the SOR indication information sent by the UDM being received, the method further includes:
generating an SOR transparent container based at least on the extended steering information and the first verification credential; and
sending the SOR transparent container to the UE.

In some embodiments, in response to the SOR transparent container sent by the UDM being received, the method further includes:
sending the SOR transparent container to the UE.

In some embodiments, the extended steering information includes at least one of following:
enhanced slice awareness information;
a prioritized list of preferred stand-alone non-public network SNPN controlled by a credential holder;
a prioritized list of preferred group IDs for network selection GIN controlled by the credential holder;
a hosting network prioritized list.

In some embodiments, the enhanced slice awareness information includes: information on a preferred public land mobile network PLMN for specific single network slice selection assistance information S-NSSAI in subscription information of the UE.

In some embodiments, the preferred PLMN of the specific S-NSSAI in the subscription information of the UE includes at least one of following:
a single PLMN that supports S-NSSAI known to an HPLMN;
a list of PLMNs arranged in preference order.

In some embodiments, the hosting network prioritized list includes: indication information of a hosting network, where the indication information indicates at least one of following:
time information of when the hosting network is valid;
location information of where the hosting network is valid.

According to a fourth aspect of embodiments of the present disclosure, an information transmission method is proposed, which is performed by user equipment UE and includes:
receiving extended steering information and a first verification credential sent by an access and mobility management function AMF, where the first verification credential is used by the UE for performing integrity verification of on the extended steering information, and the first verification credential is determined at least according to the extended steering information.

In some embodiments, the method further includes:
determining a second verification credential based at least on the extended steering information; and
performing verification on the extended steering information based on the first verification credential and the second verification credential.

In some embodiments, receiving the extended steering information and the first verification credential sent by the AMF includes:
receiving a steering of roaming SOR transparent container sent by the AMF, where the SOR transparent container carries the extended steering information and/or the first verification credential.

In some embodiments, the extended steering information includes at least one of following:
enhanced slice awareness information;
a prioritized list of preferred stand-alone non-public network SNPN controlled by a credential holder;
a prioritized list of preferred group IDs for network selection GIN controlled by the credential holder;
a hosting network prioritized list.

In some embodiments, the enhanced slice awareness information includes: information on a preferred public land mobile network PLMN for specific single network slice selection assistance information S-NSSAI in subscription information of the UE.

In some embodiments, the preferred PLMN of the specific S-NSSAI in the subscription information of the UE includes at least one of following:
a single PLMN that supports S-NSSAI known to an HPLMN;
a list of PLMNs arranged in preference order.

In some embodiments, the hosting network prioritized list includes: indication information of a hosting network, where the indication information indicates at least one of following:
time information of when the hosting network is valid;
location information of where the hosting network is valid.

According to a fifth aspect of embodiments of the present disclosure, an information transmission apparatus is proposed, which is equipped in a unified data management UDM and includes:
a first transceiving module, configured to set, for extended steering information to be sent, a first verification credential used for integrity verification of user equipment UE on the extended steering information, where the first verification credential is determined at least according to the extended steering information.

In some embodiments, the first transceiving module is further configured to:
send the extended steering information to at least an authentication service function (AUSF), where the extended steering information is used for determination of the AUSF on the first verification credential; and
receive the first verification credential determined by the AUSF.

In some embodiments, the first transceiving module is specifically configured to:
send the extended steering information and the first verification credential to an access and mobility management function (AMF), where the extended steering information and the first verification credential are to be sent to the UE by the AMF.

In some embodiments, the extended steering information is at least used for determination of the UE on a second verification credential, and for verification of the UE on the extended steering information based on the first verification credential and the second verification credential.

In some embodiments, the first transceiving module is specifically configured to perform one of the following:
sending a steering of roaming (SOR) transparent container to the AMF, where the SOR transparent container carries the extended steering information and/or the first verification credential;
sending SOR indication information to the AMF, where the extended steering information and the first verification credential are respectively carried in information elements IEs of the SOR indication information.

In some embodiments, the extended steering information includes at least one of following:
enhanced slice awareness information;
a prioritized list of preferred stand-alone non-public network SNPN controlled by a credential holder;
a prioritized list of preferred group IDs for network selection GIN controlled by the credential holder;
a hosting network prioritized list.

In some embodiments, the enhanced slice awareness information includes: information on a preferred public land mobile network PLMN for specific single network slice selection assistance information (S-NSSAI) in subscription information of the UE.

In some embodiments, the information on the preferred PLMN of the specific S-NSSAI in the subscription information of the UE includes at least one of following:
a single PLMN that supports S-NSSAI known to an HPLMN;
a list of PLMNs arranged in preference order.

In some embodiments, the hosting network prioritized list includes: indication information of a hosting network, where the indication information indicates at least one of following:
time information of when the hosting network is valid;
location information of where the hosting network is valid.

According to a sixth aspect of embodiments of this disclosure, an information transmission apparatus is proposed, which is equipped in an authentication service function AUSF and includes:
a first processing module, configured to set, for extended steering information, a first verification credential used for integrity verification of user equipment UE on the extended steering information, where the first verification credential is determined at least according to the extended steering information.

In some embodiments, the apparatus includes:
a second receiving module, configured to receive the extended steering information sent by a unified data management UDM;
where the first processing module is specifically configured to determine the first verification credential based at least on the extended steering information; and
the second receiving module is further configured to send the first verification credential to the UDM.

In some embodiments, the extended steering information is at least used for determination of the UE on a second verification credential, and for verification of the UE on the extended steering information based on the first verification credential and the second verification credential.

In some embodiments, the extended steering information includes at least one of following:
enhanced slice awareness information;
a prioritized list of preferred stand-alone non-public network (SNPN) controlled by a credential holder;
a prioritized list of preferred group IDs for network selection (GIN) controlled by the credential holder;
a hosting network prioritized list.

In some embodiments, the enhanced slice awareness information includes: information on a preferred public land mobile network PLMN for specific single network slice selection assistance information S-NSSAI in subscription information of the UE.

In some embodiments, the preferred PLMN of the specific S-NSSAI in the subscription information of the UE includes at least one of following:
a single PLMN that supports S-NSSAI known to an HPLMN;
a list of PLMNs arranged in preference order.

In some embodiments, the hosting network prioritized list includes: indication information of a hosting network, where the indication information indicates at least one of following:
time information of when the hosting network is valid;
location information of where the hosting network is valid.

According to a seventh aspect of embodiments of the present disclosure, an information transmission apparatus is proposed, which is equipped in an access and mobility management function AMF and includes:
a third transceiving module, configured to receive extended steering information and a first verification credential sent by a unified data management UDM, where the first verification credential is used for integrity verification of user equipment UE on the extended steering information, and the first verification credential is determined at least according to the extended steering information.

In some embodiments, the third transceiving module is further configured to:
send the extended steering information and the first verification credential to the UE, where the extended steering information is at least used for determination of the UE on a second verification credential, and for verification of the UE on the extended steering information based on the first verification credential and the second verification credential.

In some embodiments, the third transceiving module is specifically configured to perform one of the following:
receiving a steering of roaming SOR transparent container sent by the UDM, where the SOR transparent container carries the extended steering information and/or the first verification credential;
receiving SOR indication information sent by the UDM, where the extended steering information and the first verification credential are respectively carried in the information elements IEs of the SOR indication information.

In some embodiments, in response to the SOR indication information sent by the UDM being received, the apparatus further includes:
a second processing module, configured to generate an SOR transparent container based at least on the extended steering information and the first verification credential; and
the third transceiving module is specifically configured to send the SOR transparent container to the UE.

In some embodiments, in response to the SOR transparent container sent by the UDM being received, the apparatus further includes:
the third transceiving module, specifically configured to send the SOR transparent container to the UE.

In some embodiments, the extended steering information includes at least one of following:
enhanced slice awareness information;
a prioritized list of preferred stand-alone non-public network SNPN controlled by a credential holder;
a prioritized list of preferred group IDs for network selection GIN controlled by the credential holder;
a hosting network prioritized list.

In some embodiments, the enhanced slice awareness information includes: information on a preferred public land mobile network PLMN for specific single network slice selection assistance information S-NSSAI in subscription information of the UE.

In some embodiments, the preferred PLMN of the specific S-NSSAI in the subscription information of the UE includes at least one of following:
a single PLMN that supports S-NSSAI known to an HPLMN;
a list of PLMNs arranged in preference order.

In some embodiments, the hosting network prioritized list includes: indication information of a hosting network, where the indication information indicates at least one of following:
time information of when the hosting network is valid;
location information of where the hosting network is valid.

According to an eighth aspect of embodiments of the present disclosure, an information transmission apparatus is proposed, which is equipped in user equipment UE and includes:
a fourth transceiving module, configured to receive extended steering information and a first verification credential sent by an access and mobility management function AMF, where the first verification credential is used by the UE for performing integrity verification of on the extended steering information, and the first verification credential is determined at least according to the extended steering information.

In some embodiments, the apparatus further includes a third processing module configured to:
determine a second verification credential based at least on the extended steering information; and
perform verification on the extended steering information based on the first verification credential and the second verification credential.

In some embodiments, the fourth transceiving module is specifically configured to:
receive a steering of roaming SOR transparent container sent by the AMF, where the SOR transparent container carries the extended steering information and/or the first verification credential.

In some embodiments, the extended steering information includes at least one of following:
enhanced slice awareness information;
a prioritized list of preferred stand-alone non-public network SNPN controlled by a credential holder;
a prioritized list of preferred group IDs for network selection GIN controlled by the credential holder;
a hosting network prioritized list.

In some embodiments, the enhanced slice awareness information includes: information on a preferred public land mobile network PLMN for specific single network slice selection assistance information S-NSSAI in subscription information of the UE.

In some embodiments, the preferred PLMN of the specific S-NSSAI in the subscription information of the UE includes at least one of following:
a single PLMN that supports S-NSSAI known to an HPLMN;
a list of PLMNs arranged in preference order.

In some embodiments, the hosting network prioritized list includes: indication information of a hosting network, where the indication information indicates at least one of following:
time information of when the hosting network is valid;
location information of where the hosting network is valid.

According to a ninth aspect of embodiments of the present disclosure, a communication device is proposed, including:
a processor; and
a memory, configured to store executable instructions of the processor;
where, the processor is configured to, upon running the executable instructions, implement the information transmission method according to any embodiment of the first aspect or the second aspect or the third aspect or the fourth aspect.

According to a tenth aspect of embodiments of the present disclosure, a computer storage medium is proposed, storing an executable program of computer thereon, where the executable program is used for, upon being executed by a processor, implementing the information transmission method according to any embodiment of the first aspect or the second aspect or the third aspect or the fourth aspect.

According to the information transmission methods and apparatuses, the communication device, and the storage medium provided by some embodiments of the present disclosure, the unified data management (UDM) of the home public land network (HPLMN) is configured to implement steps including: setting, for extended steering information to be sent, a first verification credential used for integrity verification of user equipment (UE) on the extended steering information, where the first verification credential is determined at least according to the extended steering information. In this way, based on the first verification credential set for integrity verification on the extended steering information to be sent, the UE can perform integrity verification based at least on the first verification credential, thereby alleviating situations where the UE cannot determine whether the extended steering information has been tampered with, and improving the transmission security of the extended steering information.

It is to be understood that the foregoing general description and the following detailed description are exemplary and explanatory only, and are not restrictive of the present disclosure.

### BRIEF DESCRIPTION OF THE DRAWINGS

The accompanying drawings, which are incorporated in and constitute a part of this specification, illustrate some embodiments consistent with the present disclosure and, together with the description, serve to explain the principles of the present disclosure.

FIG. 1 is a schematic structural diagram of a wireless communication system according to an exemplary embodiment.

FIG. 2 is a schematic flow chart of an information transmission method according to an exemplary embodiment.

FIG. 3 is a schematic flow chart of an information transmission method according to an exemplary embodiment.

FIG. 4 is a schematic flow chart of an information transmission method according to an exemplary embodiment.

FIG. 5 is a schematic flow chart of an information transmission method according to an exemplary embodiment.

FIG. 6 is a schematic flow chart of an information transmission method according to an exemplary embodiment.

FIG. 7 is a schematic flow chart of an information transmission method according to an exemplary embodiment.

FIG. 8 is a schematic flow chart of an information transmission method according to an exemplary embodiment.

FIG. 9 is a schematic flow chart of an information transmission method according to an exemplary embodiment.

FIG. 10 is a flow chart of an information transmission method according to an exemplary embodiment.

FIG. 11 is a block diagram of an information transmission apparatus according to an exemplary embodiment.

FIG. 12 is a block diagram of an information transmission apparatus according to an exemplary embodiment.

FIG. 13 is a block diagram of an information transmission apparatus according to an exemplary embodiment.

FIG. 14 is a block diagram of an information transmission apparatus according to an exemplary embodiment.

FIG. 15 is a block diagram of UE according to an exemplary embodiment.

FIG. 16 is a block diagram of a base station according to an exemplary embodiment.

### DETAILED DESCRIPTION

Exemplary embodiments will be described in detail herein, examples of which are shown in the accompanying drawings. When the following description refers to the drawings, unless otherwise indicated, the same numbers in different drawings represent the same or similar elements. The implementations described in the following exemplary embodiments do not represent all implementations consistent with the embodiments of the present invention. Instead, they are merely examples of apparatuses and methods consistent with some aspects of the embodiments of the present invention as detailed in the appended claims.

The terms used in the disclosed embodiments are only for the purpose of describing specific embodiments and are not intended to limit the disclosed embodiments. The singular forms of “a”, “said” and “the” used in the disclosed embodiments and the appended claims are also intended to include plural forms unless the context clearly indicates other meanings. It should also be understood that the term “and/or” used herein refers to and includes any or all possible combinations of one or more associated listed items.

It should be understood that although the terms “first”, “second”, “third”, etc. may be used to describe various information in the disclosed embodiments, such information should not be limited to these terms. These terms are only used to distinguish the same type of information from each other. For example, without departing from the scope of the disclosed embodiments, the first information may also be referred to as the second information, and similarly, the second information may also be referred to as the first information. Depending on the context, the word “if” as used herein may be interpreted as “when” or “upon” or “in response to determining”.

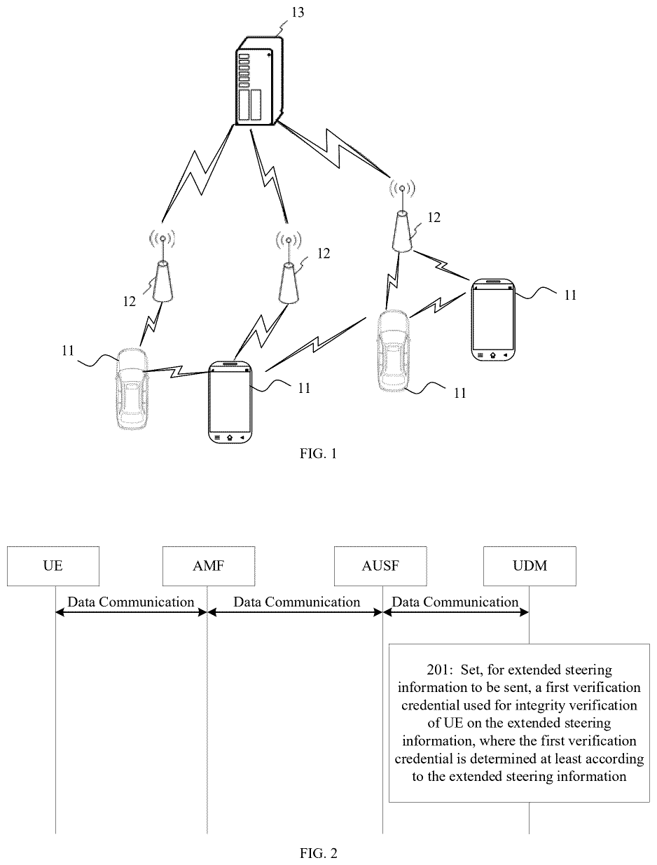

Referring to FIG. 1, which shows a schematic structural diagram of a wireless communication system according to an embodiment of the present disclosure. As shown in FIG. 1, the wireless communication system is a communication system based on cellular mobile communication technology, and the wireless communication system may include: one or more terminals 11 and one or more base stations 12.

Herein, the terminal 11 can be a device that provides voice and/or data connectivity to the user. The terminal 11 can communicate with one or more core network devices via a radio access network (RAN). The terminal 11 can be an Internet of Things (IoT) terminal, such as a sensor device, a mobile phone (or a “cellular” phone), and a computer with an IoT terminal. For example, it can be a fixed, portable, pocket-sized, handheld, computer-built-in or vehicle-mounted device, such as a station (STA), a subscriber unit, a subscriber station, a mobile station, a mobile, a remote station, an access point, a remote terminal, an access terminal, a user device, a user agent, a user device, or user equipment (UE). Alternatively, the terminal 11 can also be a device of an unmanned aerial vehicle. Alternatively, the terminal 11 can also be a vehicle-mounted device. For example, it can be a driving computer with wireless communication function, or a wireless communication device connected to an external driving computer. Alternatively, the terminal 11 may also be a roadside device, for example, a street lamp, a traffic light or other roadside device with a wireless communication function.

The base station 12 may be a network-side device in the wireless communication system. The wireless communication system may be the 4th generation mobile communication (4G) system, also known as a long term evolution (LTE) system; or, the wireless communication system may be a fifth generation mobile communication (5G) system, also known as a new radio (NR) system or a 5G NR system. Alternatively, the wireless communication system may be a next generation system of the 5G system. The access network in the 5G system may be called NG-RAN (New Generation-Radio Access Network). Alternatively, it may be an MTC system.

Herein, the base station 12 can be an evolved NodeB (eNB) adopted in the 4G system. Alternatively, the base station 12 can also be a base station (gNB) adopting a centralized-distributed architecture in the 5G system. When the base station 12 adopts the centralized-distributed architecture, it usually includes a central unit (CU) and at least two distributed units (DUs). The central unit is provided with a protocol stack of a packet data convergence protocol (PDCP) layer, a radio link control (RLC) layer, and a media access control (MAC) layer. The distributed unit is provided with a physical (PHY) layer protocol stack. The specific implementation of the base station 12 is not limited in the embodiments of the present disclosure.

A wireless connection can be established between the base station 12 and the terminal 11 through a wireless air interface. In different implementations, the wireless air interface is a wireless air interface based on the 4G standard; or, the wireless air interface is a wireless air interface based on the 5G standard. For example, the wireless air interface is a new air interface. Alternatively, the wireless air interface can also be a wireless air interface based on the next generation mobile communication network technology standard of 5G.

In some embodiments, an E2E (End to End) connection may also be established between the terminals 11, for example, in the vehicle to everything (V2X) scenarios such as V2V (vehicle to vehicle) communication, V2I (vehicle to Infrastructure) communication, and V2P (vehicle to pedestrian) communication.

In some embodiments, the wireless communication system may further include a network management device 13.

Several base stations 12 are respectively connected to the network management device 13. The network management device 13 may be a core network device in the wireless communication system. For example, the network management device 13 may be a mobility management entity (MME) in an evolved packet core (EPC) network device. Alternatively, the network management device may also be other core network devices, such as a serving gateway (SGW), a public data network gateway (PGW), a policy and charging rules function (PCRF), a home subscriber server (HSS), or the like. The embodiments of the present disclosure do not limit the implementations of the network management device 13.

In order to facilitate the understanding of those skilled in the art, the embodiments of the present disclosure list multiple implementations to clearly illustrate the technical solutions of the embodiments of the present disclosure. Those skilled in the art can understand that the multiple implementations provided by the embodiments of the present disclosure can be executed separately, or can be executed together with the methods according to other implementations of the embodiments of the present disclosure, or can be executed together with some other methods in related art separately or in combination, which are not limited in the embodiments of the present disclosure.

During UE roaming, the HPLMN may send a steering list to the UE for UE access. The steering list may include at least one of the following: a list of preferred PLMN, and/or a list of access technology combinations, and/or a secured packet.

As UE capabilities improve, the steering list can no longer meet the UE's roaming needs. UDM can send extended steering information to the UE to provide the UE with information beside the steering list for the UE to access the network. If the extended steering information is not integrity protected, it may be tampered with by the VPLMN.

Currently, there is no mechanism that enables UDM to securely send enhanced extended steering information to UE. Therefore, how to enable UE to verify the integrity of extended steering information and improve the security of extended steering information transmission is an urgent problem to be solved.

As shown in FIG. 2, some exemplary embodiments provide an information transmission method, which may be performed by a UDM and includes a following step.

In step 201, for the extended steering information to be sent, a first verification credential is set for the UE to perform integrity verification on the extended steering information, where the first verification credential is determined at least based on the extended steering information.

Unless otherwise specified, the UDM in the embodiments may include one of the following:
UDM of HPLMN;
UDM of subscribed stand-alone non-public network (SNPN), that is, UDM of subscribed SNPN.

Unless otherwise specified, the AMF in the embodiments may include:
AMF of VPLMN where the UE is roaming;
AMF of non-subscribed SNPN of UE.

Unless otherwise specified, the AUSF in the embodiments may include one of the following:
AUSF of HPLMN;
AUSF of subscribed stand-alone non-public network (SNPN), that is, AUSF of subscribed SNPN.

In an implementation, the extended steering information can be carried in an SoR message and sent by UDM to AMF, and then sent by AMF to UE through an access network device.

In an implementation, the UE may be UE in a roaming state.

In an implementation, the UE may be connected to UE of HPLMN via a non-subscribed SNPN, thereby acquiring the SoR information.

In an implementation, the extended steering information is different from the steering list.

In an implementation, the extended steering information may be sent to UE for the first time.

In an implementation, the extended steering information may be used to update extended steering information maintained by UE.

In some embodiments, the extended steering information includes at least one of the following:
enhanced slice awareness information;
a prioritized list of preferred SNPN controlled by a credential holder;
a prioritized list of preferred group IDs for network selection GIN controlled by the credential holder;
a hosting network prioritized list.

The enhanced slice awareness information can indicate PLMN information associated with the network slice.

SNPN can support credentials of an independent third-party credential holder. Therefore, UDM can send “Credentials Holder controlled prioritized lists of preferred SNPNs” to UE.

UDM can send “Credentials Holder controlled prioritized lists of preferred GINs” to UE.

UDM can also send the hosting network prioritized list to UE.

In some embodiments, the enhanced slice awareness information includes: information on a preferred PLMN for specific single network slice selection assistance information (S-NSSAI) in subscription information of UE.

The information on the preferred PLMN for specific S-NSSAI in subscription information of UE is: “preferred PLMNs for specific S-NSSAIs in the UE subscription”.

In some embodiments, the preferred PLMN for specific S-NSSAI in subscription information of UE includes at least one of the following:
a single PLMN that is known by HPLMN to support the S-NSSAI;
a list of PLMNs arranged in preference order.

In an implementation, the preference order in the list of PLMNs in preference order may be different from the order of PLMN list provided by the basic SOR information.

In some embodiments, the hosting network prioritized list includes: indication information of a hosting network, where the indication information indicates at least one of following:
time information of when the hosting network is valid;
location information of where the hosting network is valid.

In an implementation, each hosting network in the hosting network prioritized list may have corresponding indication information, which is used to indicate time information of when the hosting network takes effect, and/or location information of UE required for when the hosting network takes effect.

In an implementation, the location information of UE includes at least one of the following: geographical location information; network location information (e.g., base station, cell, etc. where it is located).

The first verification credential may be determined through a predetermined calculation manner based at least on the extended steering information. UE may determine a second verification credential by a predetermined calculation manner based at least on the received extended steering information. Whether the extended steering information has been modified can be determined by comparing the first verification credential with the second verification credential, thereby determining the integrity of the extended steering information. Here, AUSF and UE use the same predetermined calculation manner.

Determining the first verification credential based at least on the extended steering information may include at least one of the following:
determining the first verification credential based at least on entire information content of the extended steering information;
determining the first verification credential based at least on specific information content of the extended steering information;
determining the first verification credential based at least on associated information of the extended steering information, where the associated information includes but is not limited to one of the following: the number of bits of the extended steering information.

The first verification credential may be determined by a core network device. For example, the first verification credential may be determined by AUSF.

In an implementation, the parameter used to determine the first verification credential may also include but is not limited to at least one of the following:
SOR Header;
SOR counter value (Counter_{SoR});
Steering List.

In an implementation, an algorithm used to determine the first verification credential may include, but is not limited to: a KDF (Key Derivation Function) algorithm.

In an implementation, UDM may send the extended steering information to UE together with the steering list.

The extended steering information and the steering list may share the first verification credential for integrity verification.

In this way, the first verification credential for integrity verification is set for the sent extended steering information, so UE can perform integrity verification based at least on the first verification credential, thereby alleviating situations where the UE cannot determine whether the extended steering information has been tampered with, and improving the transmission security of the extended steering information.

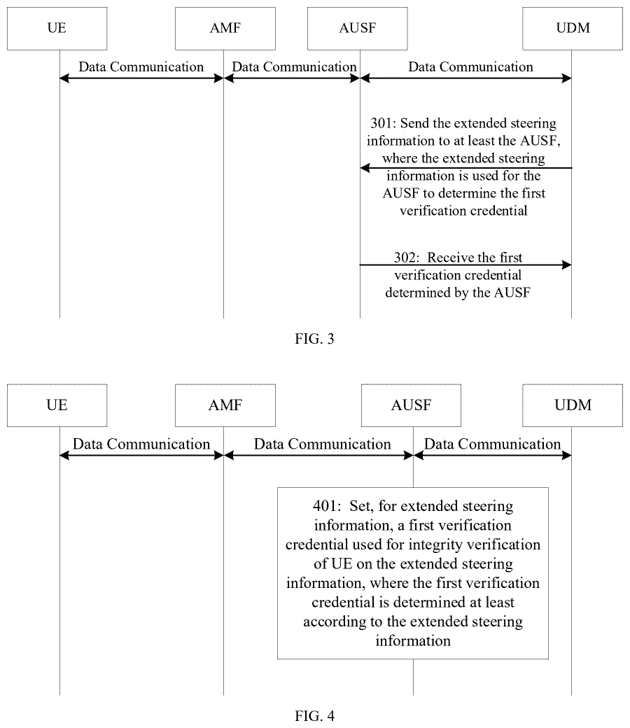

As shown in FIG. 3, some exemplary embodiments provide an information transmission method, which can be performed by UDM and includes following steps.

In step 301, extended steering information is at least sent to AUSF, where the extended steering information is used for AUSF to determine the first verification credential.

In step 303, the first verification credential determined by AUSF is received.

Here, the first verification credential can be determined by AUSF.

In an implementation, UDM may also send to AUSF at least one of the following for determining the first verification credential: an SOR header; a steering list.

In an implementation, AUSF may also send to UDM a parameter(s) for determining the first verification credential, such as an SOR counter value (Counter_{SoR}) and the like.

In an implementation, UDM may request the first verification credential from AUSF during registration procedure of UE.

Here, the object registered by UE may include HPLMN or a subscribed SNPN, which is not limited here.

In an implementation, UDM may request the first verification credential from AUSF when the extended steering information of UE needs to be updated after UE is registered.

Here, the object registered by UE may include HPLMN or the subscribed SNPN, which is not limited here. In an implementation, the first verification credential may be represented by SoR-MAC-I_{AUSF}.

Exemplarily, the extended steering information and the steering list may jointly use the first verification credential for integrity verification.

The first verification credential (SoR-MAC-I_{AUSF}) can be determined based on the authentication service function key KAUSF. The following parameters are used for constituting the input S of the KDF algorithm:
FC=the algorithm number to be assigned;
P0=SOR Header;
L0=length of the SOR header;
P1=SOR counter value (Counter_{SoR});
L1=length of the SOR counter value (Counter_{SoR});
P2=extended steering information and/or steering list and/or SoR transparent container;
L2=P2 data length.

After determining the first verification credential, AUSF may send the first verification credential to UDM.

AUSF may also send to UDM other parameters for determining the first verification credential. Other parameters for determining the first verification credential include but are not limited to at least one of the following: SOR Header; SOR Counter value (Counter_{SoR}); steering list.

In some embodiments, the step of setting, for the extended steering information to be sent, the first verification credential for UE to perform identity authentication includes:
sending the extended steering information and the first verification credential to an access and mobility management function (AMF), where the extended steering information and the first verification credential are to be sent by AMF to UE.

In an implementation, VPLMN is to transparently forward the SOR information received from HPLMN to UE.

In an implementation, the non-subscribed SNPN is to transparently forward the SOR information received from HPLMN or subscribed SNPN to UE.

Here, the extended steering information may be carried in the SOR information.

In an implementation, UDM may also send to AMF other parameters used for determining the first verification credential. Other parameters used for determining the first verification credential include but are not limited to at least one of the following: SOR Header; SOR Counter value (Counter_{SoR}); steering list.

In an implementation, AMF may also send to UE the above-mentioned other parameters used for determining the first verification credential.

In some embodiments, the extended steering information is at least used for UE to determine a second verification credential, and to verify the extended steering information based on the first verification credential and the second verification credential.

After receiving the extended steering information and the first verification credential, UE may determine the second verification credential in the same manner as determining the first verification credential.

The way in which UE determines the second verification credential may be similar to that of the core network device (e.g., AUSF), which will not be elaborated here.

In an implementation, UE may receive other parameters used for determining the first verification credential sent by AMF, and determine the first verification credential based on the extended steering information and the other received parameters. Other parameters used for determining the first verification credential include, but are not limited to, at least one of the following: SOR Header; SOR counter value (Counter_{SoR}); steering list.

In an implementation, the second verification credential may be represented by SOR-XMAC-I_{AUSF} or SOR-MAC-I_{AUSF}, which is not limited here.

Since UE and the core network device respectively determine the second verification credential and the first verification credential in the same manner, if the extended steering information has not been tampered with, the second verification credential should be equal to the first verification credential.

If the second verification credential is the same as the first verification credential, UE may determine that the extended steering information has not been tampered with.

If the second verification credential is different from the first verification credential, UE may determine that the extended steering information has been tampered with.

In this way, UE can perform integrity verification based at least on the first verification credential, thereby alleviating situations where the UE cannot determine whether the extended steering information has been tampered with, and improving the transmission security of the extended steering information.

In some embodiments, sending the extended steering information and the first verification credential to AMF comprises one of the following:
sending an SOR transparent container to AMF, where the SOR transparent container carries the extended steering information and/or the first verification credential;
sending SOR indication information to AMF, where the extended steering information and the first verification credential are respectively carried in information elements (IEs) of the SOR indication information.

If AMF supports SoR transparent container, UDM can carry the extended steering information and the first verification credential in the SoR transparent container and send it to AMF.

In an implementation, the SoR transparent container may also carry other parameters used for determining the first verification credential, including but not limited to at least one of the following: SOR Header; SOR counter value (Counter_{SoR}); steering list.

AMF may send the SoR transparent container carrying the extended steering information and the first verification credential to UE.

UDM can also carry the extended steering information and the first verification credential in a single IE(s) and send it to AMF separately.

AMF may put the extended steering information and the first verification credential carried in the IE(s) into a SoR transparent container and send it to UE.

In an implementation, UDM may send to AMF a single IE consisting of an ACK indication, a steering list (if provided), a first verification credential (SoR-MAC-I_{AUSF}F), and a SOR counter value (Counter_{SoR}) in the access and mobile subscription data. AMF may put the content carried in the IE into a SoR transparent container and send it to UE.

Exemplarily, AMF may construct an SOR header based on the ACK indication, the steering list (if provided), the first verification credential (SoR-MAC-I_{AUSF}F), and the SOR counter value (Counter_{SoR}) in the access and mobile subscription data carried by the single IE, and put the SOR header into a SoR transparent container and send it to UE.

UE may obtain the extended steering information and the first verification credential by receiving the SoR transparent container, and determine the second verification credential based at least on the extended steering information.

In an implementation, UE may also obtain other parameters used for determining the first verification credential in the SoR transparent container, and use them for determining the second verification credential.

As shown in FIG. 4, some exemplary embodiments provide an information transmission method, which is performed by an AUSF and includes a following step.

In step 401, for extended steering information, a first verification credential is set for UE to perform integrity verification on the extended steering information, where the first verification credential is determined at least based on the extended steering information.

Unless otherwise specified, the UDM in the embodiments may include one of the following:
UDM of HPLMN;
UDM of subscribed stand-alone non-public network (SNPN), that is, UDM of subscribed SNPN.

Unless otherwise specified, the AMF in the embodiments may include:
AMF of VPLMN where the UE is roaming;
AMF of non-subscribed SNPN of UE.

Unless otherwise specified, the AUSF in the embodiments may include one of the following:
AUSF of HPLMN;
AUSF of subscribed stand-alone non-public network (SNPN), that is, AUSF of subscribed SNPN.

In an implementation, the extended steering information can be carried in an SoR message and sent by UDM to AMF, and then sent by AMF to UE through an access network device.

In an implementation, the UE may be UE in a roaming state.

In an implementation, the UE may be connected to UE of HPLMN via a non-subscribed SNPN, thereby acquiring the SoR information.

In an implementation, the extended steering information is different from the steering list.

In an implementation, the extended steering information may be sent to UE for the first time.

In an implementation, the extended steering information may be used to update extended steering information maintained by UE.

In some embodiments, the extended steering information includes at least one of the following:
enhanced slice awareness information;
a prioritized list of preferred SNPN controlled by a credential holder;
a prioritized list of preferred group IDs for network selection GIN controlled by the credential holder;
a hosting network prioritized list.

The enhanced slice awareness information can indicate PLMN information associated with the network slice.

SNPN can support credentials of an independent third-party credential holder. Therefore, UDM can send “Credentials Holder controlled prioritized lists of preferred SNPNs” to UE.

UDM can send “Credentials Holder controlled prioritized lists of preferred GINs” to UE.

UDM can also send the hosting network prioritized list to UE.

In some embodiments, the enhanced slice awareness information includes: information on a preferred PLMN for specific single network slice selection assistance information (S-NSSAI) in subscription information of UE.

The information on the preferred PLMN for specific S-NSSAI in subscription information of UE is: “preferred PLMNs for specific S-NSSAIs in the UE subscription”.

In some embodiments, the preferred PLMN for specific S-NSSAI in subscription information of UE includes at least one of the following:
a single PLMN that is known by HPLMN to support the S-NSSAI;
a list of PLMNs arranged in preference order.

In an implementation, the preference order in the list of PLMNs in preference order may be different from the order of PLMN list provided by the basic SOR information.

In some embodiments, the hosting network prioritized list includes: indication information of a hosting network, where the indication information indicates at least one of following:
time information of when the hosting network is valid;
location information of where the hosting network is valid.

In an implementation, each hosting network in the hosting network prioritized list may have corresponding indication information, which is used to indicate time information of when the hosting network takes effect, and/or location information of UE required for when the hosting network takes effect.

In an implementation, the location information of UE includes at least one of the following: geographical location information; network location information (e.g., base station, cell, etc. where it is located).

The first verification credential may be determined by AUSF through a predetermined calculation manner based at least on the extended steering information. UE may determine a second verification credential by a predetermined calculation manner based at least on the received extended steering information. Whether the extended steering information has been modified can be determined by comparing the first verification credential with the second verification credential, thereby determining the integrity of the extended steering information. Here, AUSF and UE use the same predetermined calculation manner.

Determining the first verification credential based at least on the extended steering information may include at least one of the following:
determining the first verification credential based at least on entire information content of the extended steering information;
determining the first verification credential based at least on specific information content of the extended steering information;
determining the first verification credential based at least on associated information of the extended steering information, where the associated information includes but is not limited to one of the following: the number of bits of the extended steering information.

The first verification credential may be determined by a core network device. For example, the first verification credential may be determined by AUSF.

In an implementation, the parameter used to determine the first verification credential may also include but is not limited to at least one of the following:
SOR Header;
SOR counter value (Counter_{SoR});
Steering List.

In an implementation, an algorithm used to determine the first verification credential may include, but is not limited to: the KDF algorithm.

In an implementation, UDM may send the extended steering information to UE together with the steering list.

The extended steering information and the steering list may share the first verification credential for integrity verification.

In this way, the first verification credential for integrity verification is set for the sent extended steering information, so UE can perform integrity verification based at least on the first verification credential, thereby alleviating situations where the UE cannot determine whether the extended steering information has been tampered with, and improving the transmission security of the extended steering information.

In some embodiments, setting, for the extended steering information, the first verification credential for UE to perform integrity verification on the extended steering information includes:
receiving the extended steering information sent by unified data management (UDM);
determining the first verification credential based at least on the extended steering information; and
sending the first verification credential to UDM.

Here, the first verification credential may be determined by AUSF.

In an implementation, AUSF may also receive at least one of the following sent by UDM for determining the first verification credential: an SOR header; a steering list.

In an implementation, AUSF may also receive a parameter sent by UDM for determining the first verification credential, such as an SOR counter value (Counter_{SoR}) and the like.

In an implementation, UDM may request the first verification credential from AUSF during registration procedure of UE.

Here, the object registered by UE may include HPLMN or a subscribed SNPN, which is not limited here.

In an implementation, UDM may request the first verification credential from AUSF when the extended steering information of UE needs to be updated after UE is registered.

Here, the object registered by UE may include HPLMN or the subscribed SNPN, which is not limited here. In an implementation, the first verification credential may be represented by SoR-MAC-I_{AUSF}.

Exemplarily, the extended steering information and the steering list may jointly use the first verification credential for integrity verification.

The first verification credential (SoR-MAC-I_{AUSF}) can be determined based on the authentication service function key KAUSF. The following parameters are used for constituting the input S of the KDF algorithm:
FC=the algorithm number to be assigned;
P0=SOR Header;
L0=length of the SOR header;
P1=SOR counter value (Counter_{SoR});
L1=length of the SOR counter value (Counter_{SoR});
P2=extended steering information and/or steering list and/or SoR transparent container;
L2=P2 data length.

After determining the first verification credential, AUSF may send the first verification credential to UDM.

AUSF may also send to UDM other parameters for determining the first verification credential. Other parameters for determining the first verification credential include but are not limited to at least one of the following: SOR Header; SOR Counter value (Counter_{SoR}); steering list.

In some embodiments, the extended steering information is at least used for UE to determine a second verification credential, and to verify the extended steering information based on the first verification credential and the second verification credential.

After receiving the first verification credential, UDM can send the extended steering information and the first verification credential to the access and mobility management function (AMF), where the extended steering information and the first verification credential are to be sent by AMF to UE.

In an implementation, VPLMN is to transparently forward the SOR information received from HPLMN to UE.

In an implementation, the non-subscribed SNPN is to transparently forward the SOR information received from HPLMN or subscribed SNPN to UE.

Here, the extended steering information may be carried in the SOR information.

In an implementation, UDM may also send to AMF other parameters used for determining the first verification credential. Other parameters used for determining the first verification credential include but are not limited to at least one of the following: SOR Header; SOR Counter value (Counter_{SoR}); steering list.

In an implementation, AMF may also send to UE the above-mentioned other parameters used for determining the first verification credential.

In some embodiments, the extended steering information is at least used for UE to determine a second verification credential, and to verify the extended steering information based on the first verification credential and the second verification credential.

After receiving the extended steering information and the first verification credential, UE may determine the second verification credential in the same manner as determining the first verification credential.

The way in which UE determines the second verification credential may be similar to that of the core network device (e.g., AUSF), which will not be elaborated here.

In an implementation, UE may receive other parameters used for determining the first verification credential sent by AMF, and determine the first verification credential based on the extended steering information and the other received parameters. Other parameters used for determining the first verification credential include, but are not limited to, at least one of the following: SOR Header; SOR counter value (Counter_{SoR}); steering list.

In an implementation, the second verification credential may be represented by SOR-XMAC-I_{AUSF} or SOR-MAC-I_{AUSF}, which is not limited here.

Since UE and the core network device respectively determine the second verification credential and the first verification credential in the same manner, if the extended steering information has not been tampered with, the second verification credential should be equal to the first verification credential.

If the second verification credential is the same as the first verification credential, UE may determine that the extended steering information has not been tampered with.

If the second verification credential is different from the first verification credential, UE may determine that the extended steering information has been tampered with.

In this way, UE can perform integrity verification based at least on the first verification credential, thereby alleviating situations where the UE cannot determine whether the extended steering information has been tampered with, and improving the transmission security of the extended steering information.

As shown in FIG. 5, some exemplary embodiments provide an information transmission method, which is performed by an access and mobility management function (AMF) and includes a following step.

In step 501, extended steering information and a first verification credential sent by UDM is received, where the first verification credential is provided for UE to perform integrity verification on the extended steering information, and the first verification credential is determined at least based on the extended steering information.

Unless otherwise specified, the UDM in the embodiments may include one of the following:
UDM of HPLMN;
UDM of subscribed stand-alone non-public network (SNPN), that is, UDM of subscribed SNPN.

Unless otherwise specified, the AMF in the embodiments may include:
AMF of VPLMN where the UE is roaming;
AMF of non-subscribed SNPN of UE.

Unless otherwise specified, the AUSF in the embodiments may include one of the following:
AUSF of HPLMN;
AUSF of subscribed stand-alone non-public network (SNPN), that is, AUSF of subscribed SNPN.

In an implementation, the extended steering information can be carried in an SoR message and sent by UDM to AMF, and then sent by AMF to UE through an access network device.

In an implementation, the UE may be UE in a roaming state.

In an implementation, the UE may be connected to UE of HPLMN via a non-subscribed SNPN, thereby acquiring the SoR information.

In an implementation, the extended steering information is different from the steering list.

In an implementation, the extended steering information may be sent to UE for the first time.

In an implementation, the extended steering information may be used to update extended steering information maintained by UE.

In some embodiments, the extended steering information includes at least one of the following:
enhanced slice awareness information;
a prioritized list of preferred SNPN controlled by a credential holder;
a prioritized list of preferred group IDs for network selection GIN controlled by the credential holder;
a hosting network prioritized list.

The enhanced slice awareness information can indicate PLMN information associated with the network slice.

SNPN can support credentials of an independent third-party credential holder. Therefore, UDM can send “Credentials Holder controlled prioritized lists of preferred SNPNs” to UE.

UDM can send “Credentials Holder controlled prioritized lists of preferred GINs” to UE.

UDM can also send the hosting network prioritized list to UE.

In some embodiments, the enhanced slice awareness information includes: information on a preferred PLMN for specific single network slice selection assistance information (S-NSSAI) in subscription information of UE.

The information on the preferred PLMN for specific S-NSSAI in subscription information of UE is: “preferred PLMNs for specific S-NSSAIs in the UE subscription”.

In some embodiments, the preferred PLMN for specific S-NSSAI in subscription information of UE includes at least one of the following:
a single PLMN that is known by HPLMN to support the S-NSSAI;
a list of PLMNs arranged in preference order.

In an implementation, the preference order in the list of PLMNs in preference order may be different from the order of PLMN list provided by the basic SOR information.

In some embodiments, the hosting network prioritized list includes: indication information of a hosting network, where the indication information indicates at least one of following:
time information of when the hosting network is valid;
location information of where the hosting network is valid.

In an implementation, each hosting network in the hosting network prioritized list may have corresponding indication information, which is used to indicate time information of when the hosting network takes effect, and/or location information of UE required for when the hosting network takes effect.

In an implementation, the location information of UE includes at least one of the following: geographical location information; network location information (e.g., base station, cell, etc. where it is located).

The first verification credential may be determined through a predetermined calculation manner based at least on the extended steering information. UE may determine a second verification credential by a predetermined calculation manner based at least on the received extended steering information. Whether the extended steering information has been modified can be determined by comparing the first verification credential with the second verification credential, thereby determining the integrity of the extended steering information. Here, AUSF and UE use the same predetermined calculation manner.

Determining the first verification credential based at least on the extended steering information may include at least one of the following:
determining the first verification credential based at least on entire information content of the extended steering information;
determining the first verification credential based at least on specific information content of the extended steering information;
determining the first verification credential based at least on associated information of the extended steering information, where the associated information includes but is not limited to one of the following: the number of bits of the extended steering information.

The first verification credential may be determined by a core network device. For example, the first verification credential may be determined by AUSF.

In an implementation, the parameter used to determine the first verification credential may also include but is not limited to at least one of the following:
SOR Header;
SOR counter value (Counter_{SoR});
Steering List.

In an implementation, an algorithm used to determine the first verification credential may include, but is not limited to: the KDF algorithm.

In an implementation, UDM may send the extended steering information to UE together with the steering list.

The extended steering information and the steering list may share the first verification credential for integrity verification.

In this way, the first verification credential for integrity verification is set for the sent extended steering information, so UE can perform integrity verification based at least on the first verification credential, thereby alleviating situations where the UE cannot determine whether the extended steering information has been tampered with, and improving the transmission security of the extended steering information.

Here, the first verification credential may be determined by AUSF.

In an implementation, UDM may also send to AUSF at least one of the following for determining the first verification credential: an SOR header; a steering list.

In an implementation, AUSF may also send to UDM a parameter(s) for determining the first verification credential, such as an SOR counter value (Counter_{SoR}) and the like.

In an implementation, UDM may request the first verification credential from AUSF during registration procedure of UE.

Here, the object registered by UE may include HPLMN or a subscribed SNPN, which is not limited here.

In an implementation, UDM may request the first verification credential from AUSF when the extended steering information of UE needs to be updated after UE is registered.

Here, the object registered by UE may include HPLMN or the subscribed SNPN, which is not limited here. In an implementation, the first verification credential may be represented by SoR-MAC-I_{AUSF}.

Exemplarily, the extended steering information and the steering list may jointly use the first verification credential for integrity verification.

The first verification credential (SoR-MAC--I_{AUSF}) can be determined based on the authentication service function key KAUSF. The following parameters are used for constituting the input S of the KDF algorithm:
FC=the algorithm number to be assigned;
P0=SOR Header;
L0=length of the SOR header;
P1=SOR counter value (Counter_{SoR});
L1=length of the SOR counter value (Counter_{SoR});
P2=extended steering information and/or steering list and/or SoR transparent container;
L2=P2 data length.

After determining the first verification credential, AUSF may send the first verification credential to UDM.

AUSF may also send to UDM other parameters for determining the first verification credential. Other parameters for determining the first verification credential include but are not limited to at least one of the following: SOR Header; SOR Counter value (Counter_{SoR}); steering list.

In an implementation, VPLMN is to transparently forward the SOR information received from HPLMN to UE.

In an implementation, the non-subscribed SNPN is to transparently forward the SOR information received from HPLMN or subscribed SNPN to UE.

Here, the extended steering information may be carried in the SOR information.

In an implementation, UDM may also send to AMF other parameters used for determining the first verification credential. Other parameters used for determining the first verification credential include but are not limited to at least one of the following: SOR Header; SOR Counter value (Counter_{SoR}); steering list.

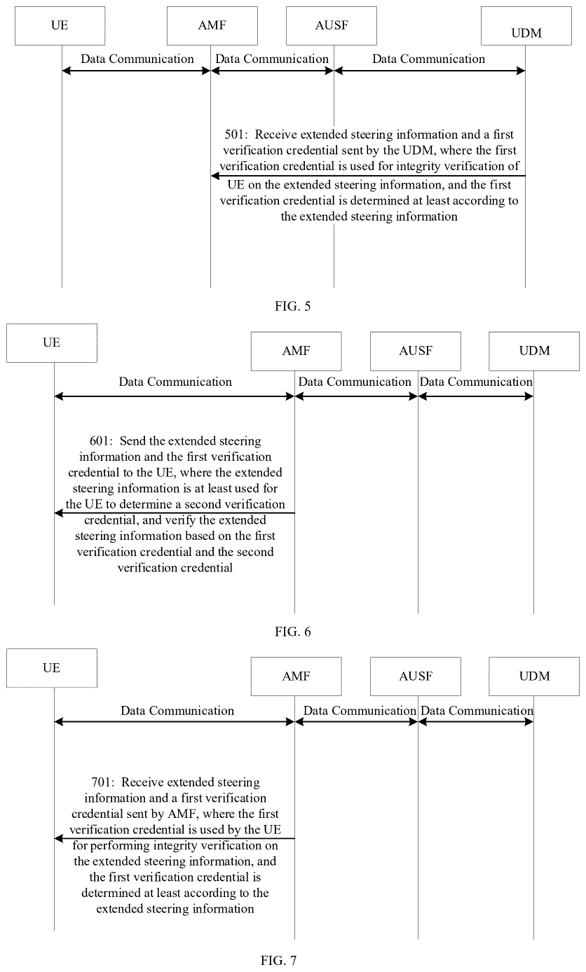

As shown in FIG. 6, some exemplary embodiments provide an information transmission method, which is performed by an access and mobility management function (AMF) and includes a following step.

In step 601, extended steering information and a first verification credential is sent to UE, where the extended steering information is at least used for UE to determine a second verification credential, and to verify the extended steering information based on the first verification credential and the second verification credential.

In an implementation, AMF may also send to UE the above-mentioned other parameters for determining the first verification credential.

In some embodiments, the extended steering information is at least used for UE to determine the second verification credential, and to verify the extended steering information based on the first verification credential and the second verification credential.

After receiving the extended steering information and the first verification credential, UE may determine the second verification credential in the same manner as determining the first verification credential.

The way in which UE determines the second verification credential may be similar to that of the core network device (e.g., AUSF), which will not be elaborated here.

In an implementation, UE may receive other parameters sent by AMF for determining the first verification credential, and determine the first verification credential based on the extended steering information and the other received parameters. Other parameters for determining the first verification credential include, but are not limited to, at least one of the following: SOR Header; SOR counter value (Counter_{SoR}); steering list.

In an implementation, the second verification credential may be represented by SOR-XMAC-I_{AUSF} or SOR-MAC-I_{AUSF}, which is not limited here.

Since UE and the core network device respectively determine the second verification credential and the first verification credential in the same manner, if the extended steering information has not been tampered with, the second verification credential should be equal to the first verification credential.

If the second verification credential is the same as the first verification credential, UE may determine that the extended steering information has not been tampered with.

If the second verification credential is different from the first verification credential, UE may determine that the extended steering information has been tampered with.

In this way, UE can perform integrity verification based at least on the first verification credential, thereby alleviating situations where the UE cannot determine whether the extended steering information has been tampered with, and improving the transmission security of the extended steering information.

In some embodiments, receiving the extended steering information and the first verification credential sent by the unified data management (UDM) includes one of the following:
receiving an SOR transparent container sent by UDM, where the SOR transparent container carries: the extended steering information and the first verification credential;
receiving an SOR transparent container and the first verification credential sent by UDM, where the SOR transparent container carries the extended steering information;
receiving SOR indication information sent by UDM, where the extended steering information and the first verification credential are respectively carried in information element(s) (IE(s)) of the SOR indication information.

If AMF supports SoR transparent container, UDM can carry the extended steering information and the first verification credential in the SoR transparent container and send it to AMF.

In an implementation, the SoR transparent container may also carry other parameters for determining the first verification credential, including but not limited to at least one of the following: SOR Header; SOR counter value (Counter_{SoR}); steering list.

In some embodiments, in response to receiving the SOR transparent container sent by UDM, the method further includes:
sending the SOR transparent container to UE.

AMF may send the SoR transparent container carrying the extended steering information and the first verification credential to UE.

In some embodiments, in response to receiving the SOR indication information sent by UDM, the method further includes:
generating an SOR transparent container based at least on the extended steering information and the first verification credential; and
sending the SOR transparent container to UE.

UDM can also carry the extended steering information and the first verification credential in a single IE(s) and send it to AMF separately.

AMF may put the extended steering information and the first verification credential carried in the IE(s) into a SoR transparent container and send it to UE.

In an implementation, UDM may send to AMF a single IE(s) consisting of an ACK indication, a steering list (if provided), a first verification credential (SoR-MAC-I_{AUSF}F), and an SOR counter value (Counter_{SoR}) in the access and mobile subscription data. AMF may put the content carried in the IE(s) into an SoR transparent container and send it to UE.

Exemplarily, AMF may construct an SOR header based on the ACK indication, the steering list (if provided), the first verification credential (SoR-MAC-I_{AUSF}F), and the SOR counter value (Counter_{SoR}) in the access and mobile subscription data carried by the single IE, and put the SOR header into a SoR transparent container and send it to UE.

UE may obtain the extended steering information and the first verification credential by receiving the SoR transparent container, and determine the second verification credential based at least on the extended steering information.

In an implementation, UE may also obtain other parameters used for determining the first verification credential in the SoR transparent container, and use them for determining the second verification credential.

As shown in FIG. 7, some exemplary embodiments provide an information transmission method, which is performed by user equipment (UE) and includes a following step.

In step 701, extended steering information and a first verification credential sent by AMF is received, where the first verification credential is provided for UE to perform integrity verification on the extended steering information, and the first verification credential is determined at least based on the extended steering information.

Unless otherwise specified, the UDM in the embodiments may include one of the following:
UDM of HPLMN;
UDM of subscribed stand-alone non-public network (SNPN), that is, UDM of subscribed SNPN.

Unless otherwise specified, the AMF in the embodiments may include:
AMF of VPLMN where the UE is roaming;
AMF of non-subscribed SNPN of UE.

Unless otherwise specified, the AUSF in the embodiments may include one of the following:
AUSF of HPLMN;
AUSF of subscribed stand-alone non-public network (SNPN), that is, AUSF of subscribed SNPN.

In an implementation, the extended steering information can be carried in an SoR message and sent by UDM to AMF, and then sent by AMF to UE through an access network device.

In an implementation, the UE may be UE in a roaming state.

In an implementation, the UE may be connected to UE of HPLMN via a non-subscribed SNPN, thereby acquiring the SoR information.

In an implementation, the extended steering information is different from the steering list.

In an implementation, the extended steering information may be sent to UE for the first time.

In an implementation, the extended steering information may be used to update extended steering information maintained by UE.

In some embodiments, the extended steering information includes at least one of the following:
enhanced slice awareness information;
a prioritized list of preferred SNPN controlled by a credential holder;
a prioritized list of preferred group IDs for network selection GIN controlled by the credential holder;
a hosting network prioritized list.

The enhanced slice awareness information can indicate PLMN information associated with the network slice.

SNPN can support credentials of an independent third-party credential holder. Therefore, UDM can send “Credentials Holder controlled prioritized lists of preferred SNPNs” to UE.

UDM can send “Credentials Holder controlled prioritized lists of preferred GINs” to UE.

UDM can also send the hosting network prioritized list to UE.

In some embodiments, the enhanced slice awareness information includes: information on a preferred PLMN for specific single network slice selection assistance information (S-NSSAI) in subscription information of UE.

The information on the preferred PLMN for specific S-NSSAI in subscription information of UE is: “preferred PLMNs for specific S-NSSAIs in the UE subscription”.

In some embodiments, the preferred PLMN for specific S-NSSAI in subscription information of UE includes at least one of the following:
a single PLMN that is known by HPLMN to support the S-NSSAI;
a list of PLMNs arranged in preference order.

In an implementation, the preference order in the list of PLMNs in preference order may be different from the order of PLMN list provided by the basic SOR information.

In some embodiments, the hosting network prioritized list includes: indication information of a hosting network, where the indication information indicates at least one of following:
time information of when the hosting network is valid;
location information of where the hosting network is valid.

In an implementation, each hosting network in the hosting network prioritized list may have corresponding indication information, which is used to indicate time information of when the hosting network takes effect, and/or location information of UE required for when the hosting network takes effect.

In an implementation, the location information of UE includes at least one of the following: geographical location information; network location information (e.g., base station, cell, etc. where it is located).

The first verification credential may be determined through a predetermined calculation manner based at least on the extended steering information. UE may determine a second verification credential by a predetermined calculation manner based at least on the received extended steering information. Whether the extended steering information has been modified can be determined by comparing the first verification credential with the second verification credential, thereby determining the integrity of the extended steering information. Here, AUSF and UE use the same predetermined calculation manner.

Determining the first verification credential based at least on the extended steering information may include at least one of the following:
determining the first verification credential based at least on entire information content of the extended steering information;
determining the first verification credential based at least on specific information content of the extended steering information;
determining the first verification credential based at least on associated information of the extended steering information, where the associated information includes but is not limited to one of the following: the number of bits of the extended steering information.

The first verification credential may be determined by a core network device. For example, the first verification credential may be determined by AUSF.

In an implementation, the parameter used to determine the first verification credential may also include but is not limited to at least one of the following:
SOR Header;
SOR counter value (Counter_{SoR});
Steering List.

In an implementation, an algorithm used to determine the first verification credential may include, but is not limited to: the KDF algorithm.

In an implementation, UDM may send the extended steering information to UE together with the steering list.

The extended steering information and the steering list may share the first verification credential for integrity verification.

In this way, the first verification credential for integrity verification is set for the sent extended steering information, so UE can perform integrity verification based at least on the first verification credential, thereby alleviating situations where the UE cannot determine whether the extended steering information has been tampered with, and improving the transmission security of the extended steering information.

Here, the first verification credential may be determined by AUSF.

In an implementation, UDM may also send to AUSF at least one of the following for determining the first verification credential: an SOR header; a steering list.

In an implementation, AUSF may also send to UDM a parameter for determining the first verification credential, such as an SOR counter value (Counter_{SoR}) and the like.

In an implementation, UDM may request the first verification credential from AUSF during registration procedure of UE.

Here, the object registered by UE may include HPLMN or a subscribed SNPN, which is not limited here.

In an implementation, UDM may request the first verification credential from AUSF when the extended steering information of UE needs to be updated after UE is registered.

Here, the object registered by UE may include HPLMN or the subscribed SNPN, which is not limited here. In an implementation, the first verification credential may be represented by SoR-MAC-I_{AUSF}.

Exemplarily, the extended steering information and the steering list may jointly use the first verification credential for integrity verification.

The first verification credential (SoR-MAC-I_{AUSF}) can be determined based on the authentication service function key KAUSF. The following parameters are used for constituting the input S of the KDF algorithm:
FC=the algorithm number to be assigned;
P0=SOR Header;
L0=length of the SOR header;
P1=SOR counter value (Counter_{SoR});
L1=length of the SOR counter value (Counter_{SoR});
P2=extended steering information and/or steering list and/or SoR transparent container;
L2=P2 data length.

After determining the first verification credential, AUSF may send the first verification credential to UDM.

AUSF may also send to UDM other parameters for determining the first verification credential. Other parameters for determining the first verification credential include but are not limited to at least one of the following: SOR Header; SOR Counter value (Counter_{SoR}); steering list.

UDM may send the extended steering information and the first verification credential to the access and mobility management function (AMF), where the extended steering information and the first verification credential are to be sent by AMF to UE.

In an implementation, VPLMN is to transparently forward the SOR information received from HPLMN to UE.

In an implementation, the non-subscribed SNPN is to transparently forward the SOR information received from HPLMN or subscribed SNPN to UE.

Here, the extended steering information may be carried in the SOR information.

In an implementation, UDM may also send to AMF other parameters used for determining the first verification credential. Other parameters used for determining the first verification credential include but are not limited to at least one of the following: SOR Header; SOR Counter value (Counter_{SoR}); steering list.

In an implementation, AMF may also send to UE the above-mentioned other parameters used for determining the first verification credential.

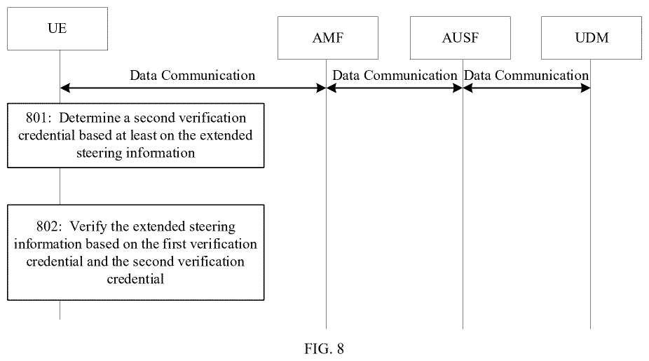

As shown in FIG. 8, some exemplary embodiments provide an information transmission method, which is performed by user equipment (UE) and includes following steps.

In step 801, a second verification credential is determined based at least on the extended steering information.

In step 802, the extended steering information is verified based on the first verification credential and the second verification credential.

In some embodiments, the extended steering information is at least used for UE to determine the second verification credential, and to verify the extended steering information based on the first verification credential and the second verification credential.

After receiving the extended steering information and the first verification credential, UE may determine the second verification credential in the same manner as determining the first verification credential.

The way in which UE determines the second verification credential may be similar to that of the core network device (e.g., AUSF), which will not be elaborated here.

In an implementation, UE may receive other parameters sent by AMF for determining the first verification credential, and determine the first verification credential based on the extended steering information and the other received parameters. Other parameters for determining the first verification credential include, but are not limited to, at least one of the following: SOR Header; SOR counter value (Counter_{SoR}); steering list.

In an implementation, the second verification credential may be represented by SOR-XMAC-I_{AUSF} Or SOR-MAC-I_{AUSF}, which is not limited here.

Since UE and the core network device respectively determine the second verification credential and the first verification credential in the same manner, if the extended steering information has not been tampered with, the second verification credential should be equal to the first verification credential.

If the second verification credential is the same as the first verification credential, UE may determine that the extended steering information has not been tampered with.

If the second verification credential is different from the first verification credential, UE may determine that the extended steering information has been tampered with.

In this way, UE can perform integrity verification based at least on the first verification credential, thereby alleviating situations where the UE cannot determine whether the extended steering information has been tampered with, and improving the transmission security of the extended steering information.

In some embodiments, receiving the extended steering information and the first verification credential sent by the access and mobility management function (AMF) includes:

receiving an SOR transparent container sent by AMF, where the SOR transparent container carries the extended steering information and/or the first verification credential.

If AMF supports SoR transparent container, UDM can carry the extended steering information and the first verification credential in the SoR transparent container and send it to AMF.

In an implementation, the SoR transparent container may also carry other parameters for determining the first verification credential, including but not limited to at least one of the following: SOR Header; SOR counter value (Counter_{SoR}); steering list.

AMF may send the SoR transparent container carrying the extended steering information and the first verification credential to UE.

UDM can also carry the extended steering information and the first verification credential in a single IE(s) and send it to AMF separately.

AMF may put the extended steering information and the first verification credential carried in the IE(s) into a SoR transparent container and send it to UE.

In an implementation, UDM may send to AMF a single IE(s) consisting of an ACK indication, a steering list (if provided), a first verification credential (SoR-MAC-I_{AUSF}F), and an SOR counter value (Counter_{SoR}) in the access and mobile subscription data. AMF may put the content carried in the IE(s) into an SoR transparent container and send it to UE.

Exemplarily, AMF may construct an SOR header based on the ACK indication, the steering list (if provided), the first verification credential (SoR-MAC-I_{AUSF}F), and the SOR counter value (Counter_{SoR}) in the access and mobile subscription data carried by the single IE, and put the SOR header into a SoR transparent container and send it to UE.

UE may obtain the extended steering information and the first verification credential by receiving the SoR transparent container, and determine the second verification credential based at least on the extended steering information.

In an implementation, UE may also obtain other parameters used for determining the first verification credential in the SoR transparent container, and use them for determining the second verification credential.

A specific example is provided below in combination with any of the above embodiments.

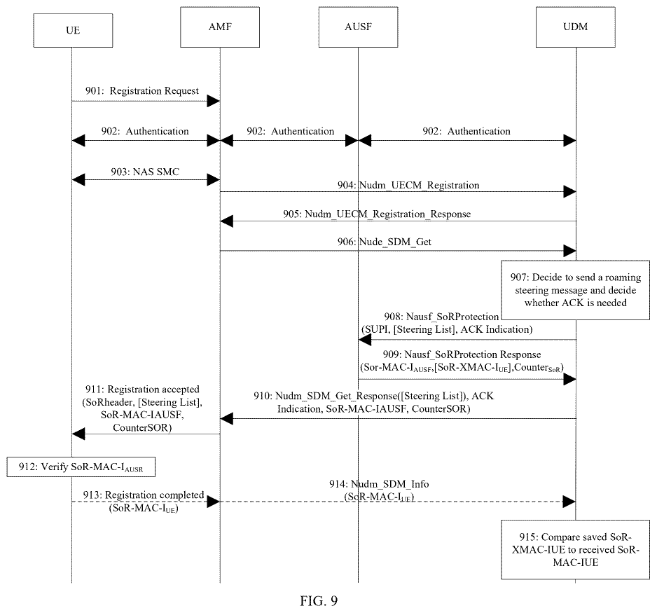

In Example 1, integrity protection of extended steering information is performed during UE registration procedure with VPLMN, as shown in FIG. 9, it specifically includes the following steps.

In step 901, UE initiates registration by sending a registration request message to AMF of VPLMN.

In steps 902-903, AMF of VPLMN performs the registration procedure. As part of the registration procedure, AMF of VPLMN performs primary authentication of UE and then, after successful authentication, initiates the non-access stratum (NAS) security mode command (SMC) procedure.

In steps 904-905, AMF of VPLMN invokes the Nudm_UECM_Registration message to UDM of HPLMN and registers access to UDM.

In step 906, AMF of VPLMN invokes the Nudm_SDM_Get service operation message to UDM to obtain information such as the access and mobility subscription data of UE.

In step 907, UDM decides to send a steering of roaming (SoR) message and obtains a steering list (which may include a preferred PLMN/radio access technology (RAT) combination list and optional additional SoR information (such as SOR-CMCI and SOR-CMCI indicator stored in ME), or a security group list) or extended steering information (including at least one of the following: enhanced slice awareness information; a prioritized list of preferred SNPN controlled by a credential holder; a prioritized list of preferred group IDs for network selection GIN controlled by the credential holder; a hosting network prioritized list). The enhanced slice awareness information includes information on a preferred PLMN for specific single network slice selection assistance information (S-NSSAI) in subscription information of UE (such as, a single PLMN that is known by HPLMN to support the S-NSSAI; a list of PLMNs arranged in preference order).

UDM can only add additional SoR information (such as SOR-CMCI and SOR-CMCI indicator stored in ME) when AMF supports SoR transparent container.

If UDM determines that UE is configured not to expect to receive steering of roaming information upon initial registration, and if UDM determines that there is no need to change the list of “operator controlled PLMN selectors and RATs” stored in UE, then UDM may not carry the steering of roaming information at all in the Nudm_SDM_Get response, thus omitting the following steps.

In steps 908-909, UDM is to invoke the Nausf_SoRProtection service operation message to AUSF to obtain the first verification credential (SoR-MAC-I_{AUSF}) and the SOR counter value (Counter_{SoR}). UDM is to select AUSF that holds the latest KAUSF of UE.

If HPLMN determines that UE acknowledges successful security varification on the received SoR information, UDM is to accordingly set the ACK indication in the Nausf_SoRProtection service operation message, indicating that the expected SoR-XMAC-I_{UE} is required.

In the calculation of SoR-MAC-I_{AUSF}, the steering list, extended steering information and the SoR header are included. UE can verify that the received steering of roaming information has not been tampered with or deleted by VPLMN. The expected SoR-XMAC-I_{UE} allows UDM to verify that UE received the steering of roaming information.

In step 910, UDM responds to the Nudm_SDM_Get service operation of VPLMN's AMF, which shall include the SoR transparent container if VPLMN's AMF supports it, or shall include a single IE(s) consisting of an ACK indication, a steering list (if provided), extended steering information, SoR-MAC-I_{AUSF}, and Counter_{SoR} in the access and mobile subscription data. If UDM requests confirmation, the expected SoR-XMAC-I_{UE} is to be temporarily stored.

In step 911, If AMF of VPLMN receives the SoR transparent container from UDM, AMF of VPLMN shall include the received SoR transparent container in the registration accept message and send it to UE. If a single IE(s) is received from UDM, AMF of VPLMN shall include it in the constructed SoR transparent container according to the ACK indication and the steering list (if provided) or extended steering information, and send the constructed SoR transparent container to UE in the registration accept message.

In step 912, upon receiving the registration accept message with the SoR transparent container from AMF, UE is to calculate the second verification credential (SoR-MAC-I_{AUSF}) in the same way as AUSF on the SoR transparent container. The calculation of the second verification credential may use Counter_{SoR} and SoR header, and it is verified whether the second verification credential (SoR-MAC-I_{AUSF}) is consistent with the first verification credential (SoR-MAC-I_{AUSF}) value received in the registration accept message.

In step 913, if UDM requires UE to provide confirmation, and UE confirms that the SoR transparent container received in step 912 is provided by HPLMN, UE is to send a registration complete message to the serving AMF. UE is to generate the SoR-MAC-I_{UE} and include the generated SoR-MAC-I_{UE} in the SOR transparent container of the registration complete message.

In step 914, AMF sends the Nudm_SDM_Info request message to UDM. If a transparent container with SoR-MAC-I_{UE} is received in the registration complete message, then if AMF supports SoR transparent container, AMF is to include the received SoR transparent container in the Nudm_SDM_Info request message; otherwise, AMF is to include the SoR-MAC-I_{UE} of the received SoR transparent container in the Nudm_SDM_Info request message.

In step 915, if HPLMN indicates that UE confirms that security verification on the received roaming of steering information in step 910 is successful, UDM is to compare the received SoR-MAC-I_{UE} with the expected SoR-XMAC-I_{UE} temporarily stored by UDM in step 910.

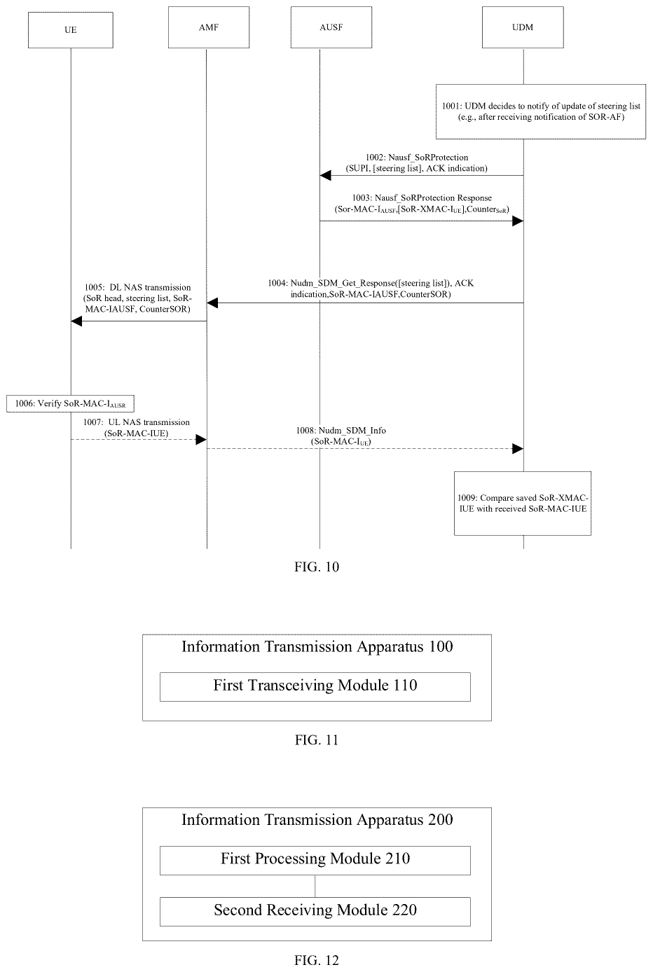

In Example 2, after UE registers with VPLMN, integrity protection performed on the extended steering information, as shown in FIG. 10, specifically includes the followings steps.

In step 1001, UDM decides to notify UE of the update of roaming steering information by invoking the Nudm_SDM_Notification service operation.

In steps 1001-1002, UDM is to invoke the Nausf_SoRProtection service operation message, including an ACK indication and a steering list (which may include a list of preferred PLMN/RAT combinations and optional additional SoR information, or a list of security groups), or extended steering information (including at least one of the following: enhanced slice awareness information; a prioritized list of preferred SNPN controlled by a credential holder; a prioritized list of preferred group IDs for network selection GIN controlled by the credential holder; a hosting network prioritized list) or an SoR transparent container (only if the transparent container is supported by AMF), to AUSF to obtain the first verification credential (SoR-MAC-I_{AUSF}) and the SOR counter value (Counter_{SoR}). UDM is to select AUSF that holds the latest KAUSF for UE.

If HPLMN decides that UE is to acknowledge successful security verification on the received SoR information, UDM is to accordingly set the ACK indication in the Nausf_SoRProtection service operation message to indicate that the expected SoR-XMAC-I_{UE} is required.

In the calculation of the first verification credential (SoR-MAC-I_{AUSF}), the steering list, extended steering information and the SoR header are included, thereby allowing UE to verify that the received SoR information has not been tampered with or deleted by VPLMN. Including this information when calculating the expected SoR-XMAC-I_{UE} allows UDM to verify that UE received the SoR information.

In step 1004, UDM is to invoke the Nudm_SDM_Notification service operation. The SoR transparent container is included if AMF of VPLMN supports it; or a single IE(s) is included, including the optional steering list, extended steering information, ACK indication, SoR-MAC-I_{AUSF} and Counter_{SoR}. If UDM requests an acknowledgment, it is to temporarily store the expected SoR-XMAC-I_{UE}.

In step 1005, after receiving the Nudm_SDM_Notification message, if the SoR transparent container is included in the message, AMF is to send a downlink non-access stratum (DL NAS) transport message to the served UE, including the received SoR transparent container. Otherwise, AMF is to construct an SOR transparent container (including the SOR header) based on the ACK indication, steering list, extended steering information, SoR-MAC-I_{AUSF} and Counter_{SoR} received from UDM, and send the constructed SoR transparent container to the served UE in the DL NAS transport message.

In step 1006, when receiving the DL NAS transport message, UE is to calculate a second verification credential (SoR-MAC-I_{AUSF}) in the same manner as that used by AUSF associated with the received SoR transparent container. The calculation of the second verification credential may use Counter_{SoR} and SoR header, and it is verified whether the second verification credential (SoR-MAC-I_{AUSF}) matches the first verification credential (SoR-MAC-I_{AUSF}) value received in the DL NAS transport message.

In step 1007, if UDM requires UE to provide confirmation and UE confirms that HPLMN has provided the steering information, UE is to send an uplink non-access stratum (UL NAS) transport message to the serving AMF. UE is to generate the SoR-MAC-QUE and include the generated SoR-MAC-I_{UE} in the SOR transparent container of the UL NAS transport message.

In step 1008, AMF is to send a Nudm_SDM_Info request message to UDM. If an SOR transparent container with SoR-MAC-QUE is received in the UL NAS transport message, AMF is to include the received SoR transparent container in the Nudm_SDM_Info request message if AMF supports SoR transparent container, otherwise AMF is to include SoR-MAC-QUE in the Nudm_SDM_Info request message.

In step 1009, if HPLMN indicates that UE is to confirm that security verification on the received roaming steering information is successful, then UDM is to compare the received SoR-MAC-I_{UE} with the expected SoR-XMAC-I_{UE} temporarily stored by UDM in step 1004.

In Embodiment 3, the first verification credential (SoR-MAC-I_{AUSF}) can be determined based on the authentication service function key KAUSF. The following parameters are used for constituting the input S of the KDF algorithm:
FC=the algorithm number to be assigned;
P0=SOR Header;
L0=length of the SOR header;
P1=SOR counter value (Counter_{SoR});
L1=length of the SOR counter value (Counter_{SoR});
P2=extended steering information and/or steering list and/or SoR transparent container;
L2=P2 data length.

The SoR-MAC-I_{AUSF} is identified using the least significant 128 bits of the KDF output.

### Embodiment 4

As an example, UDM is able to send to AUSF the extended steering information (including at least one of the following: enhanced slice awareness information; a prioritized list of preferred SNPN controlled by a credential holder; a prioritized list of preferred group IDs for network selection GIN controlled by the credential holder; a hosting network prioritized list).

As an example, AUSF is able to receive from UDM the extended steering information (including at least one of the following: enhanced slice awareness information; a prioritized list of preferred SNPN controlled by a credential holder; a prioritized list of preferred group IDs for network selection GIN controlled by the credential holder; a hosting network prioritized list).

As an example, AUSF is able to calculate SoR-MAC-I_{AUSF} using the extended steering information (including at least one of the following: enhanced slice awareness information; a prioritized list of preferred SNPN controlled by a credential holder; a prioritized list of preferred group IDs for network selection GIN controlled by the credential holder; a hosting network prioritized list).

As an example, UE is able to calculate SoR-MAC-I_{AUSF} using extended steering information (including at least one of the following: enhanced slice awareness information; a prioritized list of preferred SNPN controlled by a credential holder; a prioritized list of preferred group IDs for network selection GIN controlled by the credential holder; a hosting network prioritized list).

As shown in FIG. 11, some exemplary embodiments provide an information transmission apparatus 100, which is equipped in a unified data management (UDM) and includes: a first transceiver module 110, configured to set, for extended steering information to be sent, a first verification credential used for integrity verification of user equipment UE on the extended steering information, where the first verification credential is determined at least according to the extended steering information.

In some embodiments, the first transceiving module 110 is further configured to: send the extended steering information to at least an authentication service function (AUSF), where the extended steering information is used for determination of the AUSF on the first verification credential; and receive the first verification credential determined by the AUSF.

In some embodiments, the first transceiving module 110 is specifically configured to:
send the extended steering information and the first verification credential to an access and mobility management function (AMF), where the extended steering information and the first verification credential are to be sent to the UE by the AMF.

In some embodiments, the extended steering information is at least used for determination of the UE on a second verification credential, and for verification of the UE on the extended steering information based on the first verification credential and the second verification credential.

In some embodiments, the first transceiving module 110 is specifically configured to perform one of the following:
sending an SOR transparent container to the AMF, where the SOR transparent container carries the extended steering information and/or the first verification credential;
sending SOR indication information to the AMF, where the extended steering information and the first verification credential are respectively carried in information elements IEs of the SOR indication information.

In some embodiments, the extended steering information includes at least one of following:
enhanced slice awareness information;
a prioritized list of preferred stand-alone non-public network SNPN controlled by a credential holder;
a prioritized list of preferred group IDs for network selection GIN controlled by the credential holder;
a hosting network prioritized list.

In some embodiments, the enhanced slice awareness information includes: information on a preferred public land mobile network PLMN for specific single network slice selection assistance information (S-NSSAI) in subscription information of the UE.

In some embodiments, the information on the preferred PLMN of the specific S-NSSAI in the subscription information of the UE includes at least one of following:
a single PLMN that supports S-NSSAI known to an HPLMN;
a list of PLMNs arranged in preference order.

In some embodiments, the hosting network prioritized list includes: indication information of a hosting network, where the indication information indicates at least one of following:
time information of when the hosting network is valid;
location information of where the hosting network is valid.

As shown in FIG. 12, some exemplary embodiments provide an information transmission apparatus 200, which is equipped in a public land network authentication service function (AUSF) and includes:
a first processing module 210, configured to set, for extended steering information, a first verification credential used for integrity verification of user equipment UE on the extended steering information, where the first verification credential is determined at least according to the extended steering information.

In some embodiments, the apparatus includes:
a second receiving module 220, configured to receive the extended steering information sent by a unified data management UDM;
where the first processing module 210 is specifically configured to determine the first verification credential based at least on the extended steering information; and
the second receiving module 220 is further configured to send the first verification credential to the UDM.

In some embodiments, the extended steering information is at least used for determination of the UE on a second verification credential, and for verification of the UE on the extended steering information based on the first verification credential and the second verification credential.

In some embodiments, the extended steering information includes at least one of following:
enhanced slice awareness information;
a prioritized list of preferred stand-alone non-public network (SNPN) controlled by a credential holder;
a prioritized list of preferred group IDs for network selection (GIN) controlled by the credential holder;
a hosting network prioritized list.

In some embodiments, the enhanced slice awareness information includes: information on a preferred public land mobile network PLMN for specific single network slice selection assistance information S-NSSAI in subscription information of the UE.

In some embodiments, the preferred PLMN of the specific S-NSSAI in the subscription information of the UE includes at least one of following:
a single PLMN that supports S-NSSAI known to an HPLMN;
a list of PLMNs arranged in preference order.

In some embodiments, the hosting network prioritized list includes: indication information of a hosting network, where the indication information indicates at least one of following:
time information of when the hosting network is valid;
location information of where the hosting network is valid.

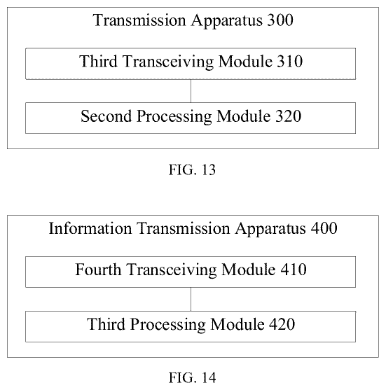

As shown in FIG. 13, some exemplary embodiments provide an information transmission apparatus 300, which is equipped in an access and mobility management function (AMF) and includes:
a third transceiver module 310, configured to extended steering information and a first verification credential sent by a unified data management UDM, where the first verification credential is used for integrity verification of user equipment UE on the extended steering information, and the first verification credential is determined at least according to the extended steering information.

In some embodiments, the third transceiving module 310 is further configured to:
send the extended steering information and the first verification credential to the UE, where the extended steering information is at least used for determination of the UE on a second verification credential, and for verification of the UE on the extended steering information based on the first verification credential and the second verification credential.

In some embodiments, the third transceiving module 310 is specifically configured to perform one of the following:
receiving a steering of roaming SOR transparent container sent by the UDM, where the SOR transparent container carries the extended steering information and/or the first verification credential;
receiving SOR indication information sent by the UDM, where the extended steering information and the first verification credential are respectively carried in the information elements IEs of the SOR indication information.

In some embodiments, in response to the SOR indication information sent by the UDM being received, the apparatus further includes:
a second processing module 320, configured to generate an SOR transparent container based at least on the extended steering information and the first verification credential; and
the third transceiving module 310 is specifically configured to send the SOR transparent container to the UE.

In some embodiments, in response to the SOR transparent container sent by the UDM being received, the apparatus further includes:
the third transceiving module 310, specifically configured to send the SOR transparent container to the UE.

In some embodiments, the extended steering information includes at least one of following:
enhanced slice awareness information;
a prioritized list of preferred stand-alone non-public network SNPN controlled by a credential holder;
a prioritized list of preferred group IDs for network selection GIN controlled by the credential holder;
a hosting network prioritized list.

In some embodiments, the enhanced slice awareness information includes: information on a preferred public land mobile network PLMN for specific single network slice selection assistance information S-NSSAI in subscription information of the UE.

In some embodiments, the preferred PLMN of the specific S-NSSAI in the subscription information of the UE includes at least one of following:
a single PLMN that supports S-NSSAI known to an HPLMN;
a list of PLMNs arranged in preference order.

In some embodiments, the hosting network prioritized list includes: indication information of a hosting network, where the indication information indicates at least one of following:
time information of when the hosting network is valid;
location information of where the hosting network is valid.

As shown in FIG. 14, some exemplary embodiments provide an information transmission apparatus 400, which is equipped in a user equipment (UE) and includes:
a fourth transceiver module 410, configured to receive extended steering information and a first verification credential sent by an access and mobility management function AMF, where the first verification credential is used by the UE for performing integrity verification of on the extended steering information, and the first verification credential is determined at least according to the extended steering information.

In some embodiments, the apparatus further includes a third processing module 420 configured to:
determine a second verification credential based at least on the extended steering information; and
perform verification on the extended steering information based on the first verification credential and the second verification credential.

In some embodiments, the fourth transceiving module 410 is specifically configured to:
receive an SOR transparent container sent by the AMF, where the SOR transparent container carries the extended steering information and/or the first verification credential.

In some embodiments, the extended steering information includes at least one of following:
enhanced slice awareness information;
a prioritized list of preferred stand-alone non-public network SNPN controlled by a credential holder;
a prioritized list of preferred group IDs for network selection GIN controlled by the credential holder;
a hosting network prioritized list.

In some embodiments, the enhanced slice awareness information includes: information on a preferred public land mobile network PLMN for specific single network slice selection assistance information S-NSSAI in subscription information of the UE.

In some embodiments, the preferred PLMN of the specific S-NSSAI in the subscription information of the UE includes at least one of following:
a single PLMN that supports S-NSSAI known to an HPLMN;
a list of PLMNs arranged in preference order.

In some embodiments, the hosting network prioritized list includes: indication information of a hosting network, where the indication information indicates at least one of following:
time information of when the hosting network is valid;
location information of where the hosting network is valid.

The present disclosure provides a communication device, including:
a processor; and
a memory, configured to store executable instructions of the processor;
where, the processor is configured to, upon running the executable instructions, implement the information transmission method according to any embodiment of the present disclosure.

In some embodiments, the communication device may include but is not limited to at least one of: UE and network device. Here, the network device may include core network or access network device, etc. Here, the access network device may include a base station; the core network may include AMF and SMF.

The processor may include various types of storage medium, which are non-transitory computer storage medium that can continue to memorize information stored thereon after the user device loses power.

The processor may be connected to the memory via a bus or the like, and may be used to read an executable program stored in the memory, for example, at least one of the methods shown in FIG. 2 to FIG. 8.

The present disclosure also provides a computer storage medium storing a computer executable program, which, when the executable program is executed by a processor, implements the information transmission method according to any embodiment of the present disclosure, for example, at least one of the methods shown in FIG. 2 to FIG. 8.

Regarding the apparatus or storage medium in the above embodiments, the specific manner in which each module performs operations has been described in detail in the embodiments of the method, and will not be elaborated here.

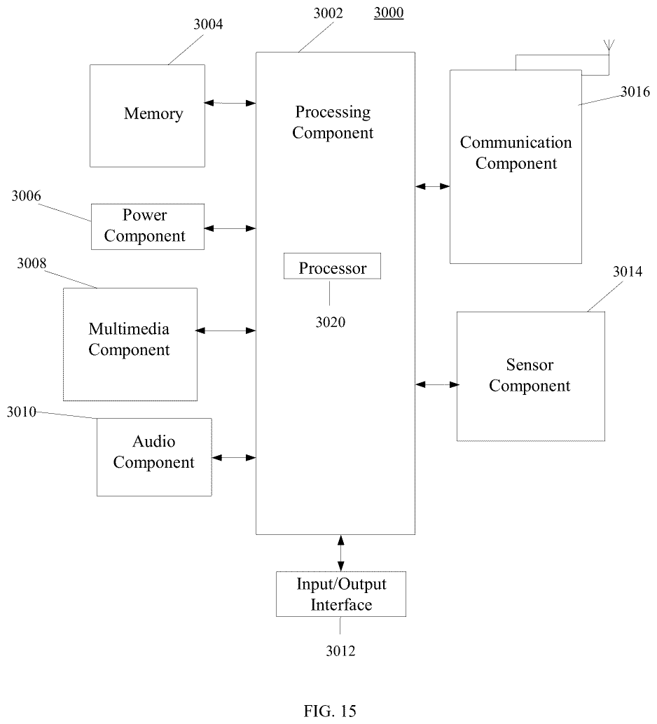

FIG. 15 is a schematic diagram of UE 3000 according to an exemplary embodiment. For example, the UE 3000 may be a mobile phone, a computer, a digital broadcast terminal, a messaging device, a game console, a tablet device, a medical device, a fitness device, a personal digital assistant, etc.

As shown in FIG. 15, UE 3000 may include one or more of the following components: a processing component 3002, a memory 3004, a power component 3006, a multimedia component 3008, an audio component 3010, an input/output (I/O) interface 3012, a sensor component 3014, and a communication component 3016.

The processing component 3002 generally controls the overall operation of the UE 3000, such as operations associated with display, phone calls, data communications, camera operations, and recording operations. The processing component 3002 may include one or more processors 3020 to execute instructions to complete all or part of the steps of the above-mentioned methods. In addition, the processing component 3002 may include one or more modules to facilitate the interaction between the processing component 3002 and other components. For example, the processing component 3002 may include a multimedia module to facilitate the interaction between the multimedia component 3008 and the processing component 3002.

The memory 3004 is configured to store various types of data to support operations on the UE 3000. Examples of such data include instructions for any application or method operating on the UE 3000, contact data, phone book data, messages, pictures, videos, etc. The memory 3004 can be implemented by any type of volatile or non-volatile storage device or a combination thereof, such as static random access memory (SRAM), electrically erasable programmable read-only memory (EEPROM), erasable programmable read-only memory (EPROM), programmable read-only memory (PROM), read-only memory (ROM), magnetic memory, flash memory, magnetic disk or optical disk.

The power component 3006 provides power to the various components of the UE 3000. The power component 3006 may include a power management system, one or more power supplies, and other components associated with generating, managing, and distributing power for the UE 3000.

The multimedia component 3008 includes a screen that provides an output interface between the UE 3000 and the user. In some embodiments, the screen may include a liquid crystal display (LCD) and a touch panel (TP). If the screen includes a touch panel, the screen may be implemented as a touch screen to receive input signals from the user. The touch panel includes one or more touch sensors to sense touch, slide, and gestures on the touch panel. The touch sensor may not only sense the boundaries of the touch or slide action, but also detect the duration and pressure associated with the touch or slide operation. In some embodiments, the multimedia component 3008 includes a front camera and/or a rear camera. When the UE 3000 is in an operating mode, such as a shooting mode or a video mode, the front camera and/or the rear camera may receive external multimedia data. Each front camera and the rear camera may be a fixed optical lens system or have a focal length and optical zoom capability.

The audio component 3010 is configured to output and/or input audio signals. For example, the audio component 3010 includes a microphone (MIC), and when the UE 3000 is in an operating mode, such as a call mode, a recording mode, and a speech recognition mode, the microphone is configured to receive an external audio signal. The received audio signal can be further stored in the memory 3004 or sent via the communication component 3016. In some embodiments, the audio component 3010 also includes a speaker for outputting audio signals.

I/O interface 812 provides an interface between processing component 3002 and peripheral interface modules, such as keyboards, click wheels, buttons, etc. These buttons may include, but are not limited to, a home button, a volume button, a start button, and a lock button.

The sensor assembly 3014 includes one or more sensors for providing various aspects of status assessment for the UE 3000. For example, the sensor assembly 3014 can detect the open/closed state of the UE 3000, the relative positioning of components, such as the display and keypad of the UE 3000, and the sensor assembly 3014 can also detect the position change of the UE 3000 or a component of the UE 3000, the presence or absence of user contact with the UE 3000, the orientation or acceleration/deceleration of the UE 3000, and the temperature change of the UE 3000. The sensor assembly 3014 may include a proximity sensor configured to detect the presence of nearby objects without any physical contact. The sensor assembly 3014 may also include an optical sensor, such as a CMOS or CCD image sensor, for use in imaging applications. In some embodiments, the sensor assembly 3014 may also include an acceleration sensor, a gyroscope sensor, a magnetic sensor, a pressure sensor, or a temperature sensor.

The communication component 3016 is configured to facilitate wired or wireless communication between the UE 3000 and other devices. The UE 3000 can access a wireless network based on a communication standard, such as WiFi, 4G or 5G, or a combination thereof. In an exemplary embodiment, the communication component 3016 receives a broadcast signal or broadcast-related information from an external broadcast management system via a broadcast channel. In an exemplary embodiment, the communication component 3016 also includes a near field communication (NFC) module to facilitate short-range communication. For example, the NFC module can be implemented based on radio frequency identification (RFID) technology, infrared data association (IrDA) technology, ultra-wideband (UWB) technology, Bluetooth (BT) technology and other technologies.

In an exemplary embodiment, the UE 3000 may be implemented by one or more application-specific integrated circuits (ASICs), digital signal processors (DSPs), digital signal processing devices (DSPDs), programmable logic devices (PLDs), field programmable gate arrays (FPGAs), controllers, microcontrollers, microprocessors, or other electronic components to perform the above methods.

In an exemplary embodiment, a non-transitory computer-readable storage medium including instructions is also provided, such as a memory 3004 including instructions, which can be executed by a processor 3020 of the UE 3000 to perform the above methods. For example, the non-transitory computer-readable storage medium can be a ROM, a random access memory (RAM), a CD-ROM, a magnetic tape, a floppy disk, an optical data storage device, etc.

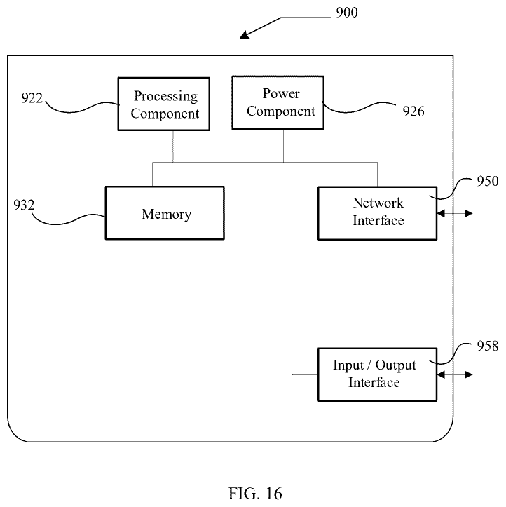

As shown in FIG. 16, an embodiment of the present disclosure shows a structure of a base station. For example, the base station 900 may be provided as a network-side device. Referring to FIG. 16, the base station 900 includes a processing component 922, which further includes one or more processors, and a memory resource represented by a memory 932 for storing instructions executable by the processing component 922, such as an application. The application stored in the memory 932 may include one or more modules, each corresponding to a set of instructions. In addition, the processing component 922 is configured to execute instructions to execute any method of the aforementioned method applied to the base station.

The base station 900 may also include a power supply component 926 configured to perform power management of the base station 900, a wired or wireless network interface 950 configured to connect the base station 900 to the network, and an input/output (I/O) interface 958. The base station 900 may operate based on an operating system stored in the memory 932, such as Windows Server™, Mac OS X™, Unix™, Linux™, FreeBSD™ or the like.

Those skilled in the art will readily appreciate other embodiments of the present invention after considering the specification and practicing the invention disclosed herein. The present disclosure is intended to cover any variations, uses or adaptations of the present invention that follow the general principles of the present invention and include common knowledge or customary techniques in the art that are not disclosed in the present disclosure. The description and examples are to be considered exemplary only, and the true scope and spirit of the present invention are indicated by the following claims.

It should be understood that the present invention is not limited to the exact construction that has been described above and shown in the drawings and that various modifications and changes may be made without departing from the scope thereof. The scope of the present invention is limited only by the appended claims.

1. An information transmission method, being performed by a unified data management (UDM) and comprising:
setting, for extended steering information to be sent, a first verification credential used for integrity verification of user equipment (UE) on the extended steering information, wherein the first verification credential is determined at least according to the extended steering information.

2. The method according to claim 1, further comprising:
sending the extended steering information to at least an authentication service function (AUSF), wherein the extended steering information is used for determination of the AUSF on the first verification credential; and
receiving the first verification credential determined by the AUSF.

3. The method according to claim 2, wherein setting, for the extended steering information to be sent, the first verification credential used for integrity verification of the UE on the extended steering information comprises:
sending the extended steering information and the first verification credential to an access and mobility management function (AMF), wherein the extended steering information and the first verification credential are to be sent to the UE by the AMF.

4. The method according to claim 2, wherein the extended steering information is at least used for determination of the UE on a second verification credential, and for verification of the UE on the extended steering information based on the first verification credential and the second verification credential.

5. The method according to claim 3, wherein sending the extended steering information and the first verification credential to the AMF comprises one of:
sending a steering of roaming (SOR) transparent container to the AMF, wherein the SOR transparent container carries at least one of the extended steering information or the first verification credential; or
sending SOR indication information to the AMF, wherein the extended steering information and the first verification credential are respectively carried in information elements (IEs) of the SOR indication information.

6.-16. (canceled)

17. An information transmission method, being performed by an access and mobility management function (AMF) and comprising:
receiving extended steering information and a first verification credential sent by a unified data management (UDM), wherein the first verification credential is used for integrity verification of user equipment (UE) on the extended steering information, and the first verification credential is determined at least according to the extended steering information.

18. The method according to claim 17, further comprising:
sending the extended steering information and the first verification credential to the UE, wherein the extended steering information is at least used for determination of the UE on a second verification credential, and for verification of the UE on the extended steering information based on the first verification credential and the second verification credential.

19. The method according to claim 17, wherein the extended steering information and the first verification credential sent by the UDM comprises one of:
receiving a steering of roaming (SOR) transparent container sent by the UDM, wherein the SOR transparent container carries at least one of the extended steering information or the first verification credential; or
receiving SOR indication information sent by the UDM, wherein the extended steering information and the first verification credential are respectively carried in the information elements (IEs) of the SOR indication information.

20. The method according to claim 19, wherein, in response to the SOR indication information sent by the UDM being received, the method further comprises:
generating an SOR transparent container based at least on the extended steering information and the first verification credential; and
sending the SOR transparent container to the UE.

21. The method according to claim 19, wherein, in response to the SOR transparent container sent by the UDM being received, the method further comprises:
sending the SOR transparent container to the UE.

22.-25. (canceled)

26. An information transmission method, being performed by user equipment (UE) and comprising:
receiving extended steering information and a first verification credential sent by an access and mobility management function (AMF), wherein the first verification credential is used by the UE for performing integrity verification of on the extended steering information, and the first verification credential is determined at least according to the extended steering information.

27. The method according to claim 26, further comprising:
determining a second verification credential based at least on the extended steering information; and
performing verification on the extended steering information based on the first verification credential and the second verification credential.

28. The method according to claim 26, wherein receiving the extended steering information and the first verification credential sent by the AMF comprises:
receiving a steering of roaming (SOR) transparent container sent by the AMF, wherein the SOR transparent container carries at least one of the extended steering information or the first verification credential.

29. The method according to claim 26, wherein the extended steering information comprises at least one of:
enhanced slice awareness information;
a prioritized list of preferred stand-alone non-public network (SNPN) controlled by a credential holder;
a prioritized list of preferred group IDs for network selection (GIN) controlled by the credential holder; or
a hosting network prioritized list.

30. The method according to claim 29, wherein the enhanced slice awareness information comprises: information on a preferred public land mobile network (PLMN) for specific single network slice selection assistance information (S-NSSAI) in subscription information of the UE.

31. The method according to claim 30, wherein the preferred PLMN of the specific S-NSSAI in the subscription information of the UE comprises at least one of:
a single PLMN that supports S-NSSAI known to an HPLMN; or
a list of PLMNs arranged in preference order.

32. The method according to claim 29, wherein
the hosting network prioritized list comprises: indication information of a hosting network, wherein the indication information indicates at least one of:
time information of when the hosting network is valid; or
location information of where the hosting network is valid.

33.-37. (canceled)

38. A unified data management (UDM) device, comprising:
a processor; and
a memory storing instructions executable by the processor;
wherein the processor is configured to perform the information transmission method according to claim 1.

39. An access and mobility management function (AMF) device, comprising:
a processor; and
a memory storing instructions executable by the processor;
wherein the processor is configured to perform the information transmission method according to claim 17.

40. A user equipment (UE), comprising:
a processor; and
a memory storing instructions executable by the processor;
wherein the processor is configured to perform the information transmission method according to claim 26.
